(19) United States
(12) Patent Application Publication
(10) Pub. No.: US 2023/0305128 A1
(43) Pub. Date: Sep. 28, 2023

(54) Miss Distance Calculation System and Method of Use

(71) Applicant: Invocon, Inc., Conroe, TX (US)

(72) Inventors: Karl Rothe, La Porte, TX (US); Donald Chaffee, Chaska, MN (US); Douglas Heermann, Conroe, TX (US); Aaron Trott, Shenandoah, TX (US)

(21) Appl. No.: 18/046,165

(22) Filed: Oct. 13, 2022

Related U.S. Application Data
(60) Provisional application No. 63/310,729, filed on Feb. 16, 2022.

(51) Int. Cl. G01S 11/10

(52) U.S. Cl. CPC G01S 11/10

(57) ABSTRACT

A method of calculating a distance between transmitters and receivers with Doppler signals for determining a miss distance of two moving vehicles using the physical phenomenon of the Doppler effect. Said method comprising: emitting a broadcast signal with a transmitter from one among the two moving vehicles and sensing and recording a portion of the broadcast signal with a signal receiver on another among the two moving vehicles, analyzing a received signal over an observation period, calculating a slope characteristic of the received signal over the observation period, and calculating the miss distance between the two moving vehicles based on the slope characteristic. wherein, the observation period comprises a starting time, a time-minimum-distance and an ending time.

### CROSS-REFERENCE TO RELATED APPLICATIONS

This application claims benefit to U.S. provisional patent application 63/310,729 filed 2022 Feb. 16.

### STATEMENT REGARDING FEDERALLY SPONSORED RESEARCH OR DEVELOPMENT (IF APPLICABLE)

Not applicable.

### REFERENCE TO SEQUENCE LISTING, A TABLE, OR A COMPUTER PROGRAM LISTING COMPACT DISC APPENDIX (IF APPLICABLE)

Not applicable.

### BACKGROUND OF THE INVENTION

One goal of this investigation is to determine a means by which measured RSSI and Doppler frequency shift of an incoming carrier can be used to estimate the nearest miss distance between an interceptor and a target. A necessary step to achieving this goal is to determine a means by which the Doppler frequency impressed upon a received signal by relative motion between transmitter and receiver can be estimated. More specifically, the transmitter is providing an RF signal modulated with telemetry data.

The normal goal in dealing with this type of signal would be to remove any carrier offset and Doppler components of the signal in order to accurately recover the modulated data. In this effort, the data is of no interest. The received signal strength will be estimated using a common Received Signal Strength Indicator (RSSI) technique and the Doppler frequency shift will be estimated using the techniques presented herein.

Although the current disclosure was developed in the context of moving vehicles—interceptor and target projectiles—the innovation would be applicable to a single moving vehicle relative to a fixed point, provided the relative movement between a transmitter 1402 and a signal receiver 112 are being tracked as discussed herein.

It is further noted that one advantage of the current approach is the ability to track a miss distance 116 when one among two moving vehicles 104 is noncooperative. For example, a test vehicle may have a specification which cannot be changed for testing. Wherein, a method of calculating a distance between transmitters and receivers with Doppler signals 300 can calculate said miss distance 116 nonetheless by means discussed herein.

In one embodiment, said method of calculating a distance between transmitters and receivers with Doppler signals 300 can be well adapted to receiving signals from an interceptor projectile from a target projectile.

In one embodiment, said method of calculating a distance between transmitters and receivers with Doppler signals 300 could operate in a complex projectile environment with more than one projectile having said transmitter 1402 and more than one projectile having said signal receiver 112.

Another example of noncooperative vehicles which may be observed using said method of calculating a distance between transmitters and receivers with Doppler signals 300 can comprise a satellite.

No prior art is known to the Applicant.

### BRIEF SUMMARY OF THE INVENTION

A method of calculating a distance between transmitters and receivers with Doppler signals for determining a miss distance of two moving vehicles using the physical phenomenon of the Doppler effect is disclosed. Comprising emitting a broadcast signal with a transmitter from one among said two moving vehicles and sensing and recording a portion of said broadcast signal with a signal receiver on another among said two moving vehicles, analyzing a received signal over an observation period, calculating a slope characteristic of said received signal over said observation period, and calculating said miss distance between said two moving vehicles based on said slope characteristic. wherein, said observation period comprises a starting time, a time-minimum-distance and an ending time.

Said method of calculating a distance between transmitters and receivers with Doppler signals for determining said miss distance between said transmitter moving along a transmitter path relative to said signal receiver using the physical phenomenon of the Doppler effect is disclosed. Comprising broadcasting said broadcast signal with said transmitter from one among said two moving vehicles and capturing and recording a portion of said broadcast signal with said signal receiver on another among said two moving vehicles, measuring a Received Signal Strength Indicator (“RSSI”) based on said received signal, measuring a change in a Doppler frequency shift in said received signal, removing any carrier offset and modulated data of said received signal to accurately recover the Doppler components, calculating a minimum distance and said time-minimum-distance between said transmitter and said signal receiver. wherein said time-minimum-distance, also referred to as an epoch, comprises a time at which said miss distance is at said minimum distance as between said signal receiver and said transmitter, and the period with said transmitter and said signal receiver passing one another is referred to as an encounter.

Said method of calculating a distance between transmitters and receivers with Doppler signals for determining said miss distance between said transmitter moving along said transmitter path relative to said signal receiver using the physical phenomenon of the Doppler effect is disclosed. Comprising broadcasting said broadcast signal with said transmitter from one among said two moving vehicles and capturing and recording a portion of said broadcast signal with said signal receiver on another among said two moving vehicles, measuring a Received Signal Strength Indicator (“RSSI”) based on said received signal, measuring a change in a Doppler frequency shift in said received signal, removing any carrier offset and modulated data of said received signal to accurately recover the Doppler components, calculating said minimum distance and said time-minimum-distance between said transmitter and said signal receiver. wherein said time-minimum-distance, also referred to as an epoch, comprises a time at which said miss distance is at said minimum distance as between said signal receiver and said transmitter, and the period with said transmitter and said signal receiver passing one another is referred to as an encounter. Said transmitter outputs a carrier signal of constant power including the modulation impressed upon said broadcast signal. wherein, said changes in the general characteristics of said received signal comprises: a signal strength due to the changing distance between said transmitter and said signal receiver, the path loss. a signal strength due to the beam pattern shapes of transmit and receive antennas. a doppler frequency shift as said transmitter moves from approaching to departing.

### BRIEF DESCRIPTION OF THE SEVERAL VIEWS OF THE DRAWING

FIGS. 1A, 1B, 2A and 2B illustrate a Doppler effect in a stationary diagram 100, an approaching vehicle diagram 102, a passing vehicle diagram 200 and a departing vehicle diagram 202, respectively.

FIGS. 3A, and 3B illustrate a Doppler frequency shift chart 310 and a method of calculating a distance between transmitters and receivers with Doppler signals 300.

FIG. 4 illustrates a velocity vector illustration 400 of two moving vehicles 104.

FIGS. 5A, 5B, 5C, 5D, 5E, and 5F illustrate a first equation 500a, a second equation 500b, a third equation 500c, a fourth equation 500d, fifth equation 500e, and a sixth equation 500f.

FIG. 6 illustrates a breakdown of the steps for the fourth equation 600.

FIGS. 7A-7B illustrate a flyby model illustration 700 and a method of calculating a miss distance using a flyby model 704.

FIGS. 8A, 8B, 8C, and 8D illustrate a seventh equation 800a, an eighth equation 800b, a ninth equation 800c, and a tenth equation 800d.

FIG. 9 illustrates a Doppler frequency shift chart 900.

FIGS. 10A, 10B, 10C, 10D, and 10E illustrate an eleventh equation 1000a, a twelfth equation 1000b, a thirteenth equation 1000c, a fourteenth equation 1000d, and a fifteenth equation 1000e.

FIGS. 11A, 11B, 11C, 11D, 11E, and 11F illustrate a sixteenth equation 1100a, a seventeenth equation 1100b, an eighteenth equation 1100c, a nineteenth equation 1100d, a twentieth equation 1100e, and a twenty-first equation 1100f.

FIGS. 12A, 12B, 12C, 12D, 12E, and 12F illustrate a twenty-second equation 1200a, a twenty-third equation 1200b, a twenty-fourth equation 1200c, a twenty-fifth equation 1200d, a twenty-sixth equation 1200e, and a twenty-seventh equation 1200f.

FIGS. 13A, and 13B illustrate an ideal method 1300 and a practical method 1302 of determining a miss distance 116.

FIG. 14 illustrates a diagram of said two moving vehicles 104 with a broadcast signal 110 moving relative to said broadcast signal 110 along a transmitter path 1400.

FIG. 15 illustrates an example of the factors between a transmitter and a receiver in a comparison table 1500.

FIG. 16 illustrates a formula.

FIGS. 17A, and 17B illustrate an S-Band antenna beam pattern and a graph.

FIGS. 18A, and 18B illustrate a table and chart.

FIGS. 19A and 19B illustrate an RF transmitter moving through space at a speed V 1904 and equation 1900.

FIGS. 20A and 20B illustrate probability density functions 2000 for a transmitter 1402 and a signal receiver 112 and table 2002.

FIG. 21 illustrates a plurality of formulas related to signal modeling.

FIG. 22 illustrates a plurality of equations related to phase difference estimation.

FIGS. 23A, 23B, and 23C respectively illustrate a miss scenario 2310, a plurality of equations, and the Doppler frequency versus time for various miss distances (7 km/s) and no carrier frequency offset.

FIG. 24A illustrates the Doppler frequency versus time for various miss distances (7 km/s) and 66 kHz carrier frequency offset.

FIG. 24B a plurality of equations related to epoch detection.

FIG. 25 illustrates a Slope of Doppler Estimates chart 2500.

FIG. 26 illustrates an exaggerated example of I/Q imbalance chart 2600.

FIG. 27 illustrates a general QPSK modulator block diagram 2700.

FIGS. 28A, 28B, and 28C illustrate an equation 2800, a basic quadrature receiver diagram 2802, and an ideal QPSK constellation 2804, respectively.

FIG. 29 illustrates a PSD chart 2900.

FIGS. 30A, and 30B illustrate a four-quadrant graphical representation 3000 of the removal of QPSK modulation, and a rotation logic table 3002, respectively.

FIGS. 31A, 31B, and 31C illustrate an IQ signals chart 3100, a constellation chart 3102 and a rotated constellation chart 3104.

FIG. 32 illustrates a chart 3200 of doppler estimation from SOQPSK-TG waveforms.

FIGS. 33A, 33B, and 33C illustrate a plurality of equations, an angle difference using coordinates diagram, and an inverse tangent function chart.

FIGS. 34A, and 34B illustrate a data sampling scheme and a plurality of equations.

### DETAILED DESCRIPTION OF THE INVENTION

The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

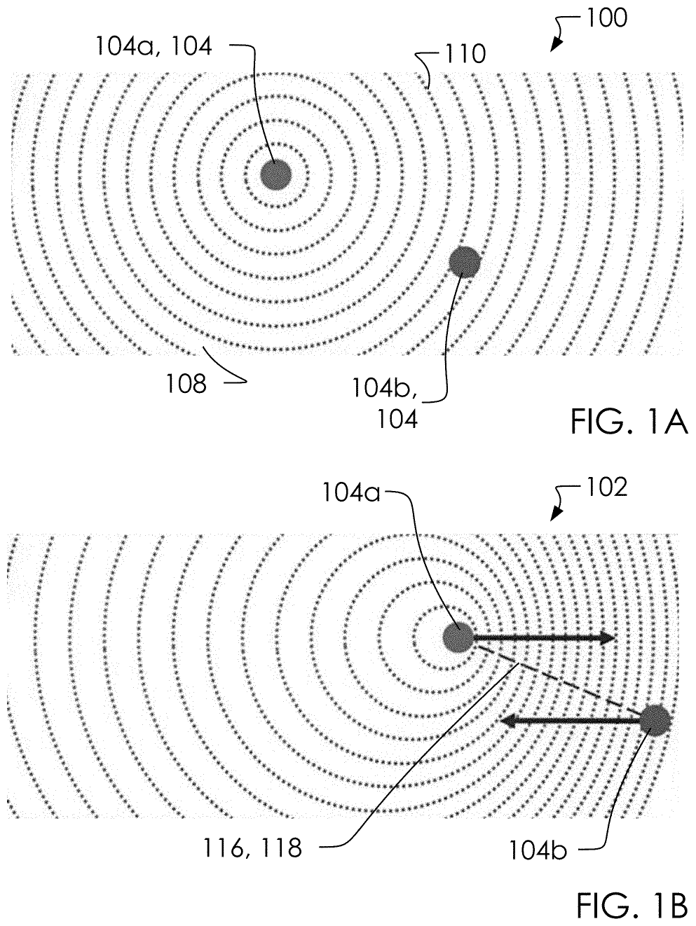

FIGS. 1A, 1B, 2A and 2B illustrate a Doppler effect in a stationary diagram 100, an approaching vehicle diagram 102, a passing vehicle diagram 200 and a departing vehicle diagram 202, respectively.

As is known in the art, the Doppler effect is the change in frequency by an observer due to the movement of a source relative to the observer.

As discussed herein, the Doppler effect can be employed to interpret the relative location of two moving bodies, such as missiles.

For discussion purposes FIG. 1A-2B introduce the physical phenomenon of the Doppler effect between two moving bodies; namely, two moving vehicles 104, referred to as a first vehicle 104b and a second vehicle 104a, located a space 108 relative to one another.

In one embodiment, said second vehicle 104a can comprise an interceptor missile and said first vehicle 104b can comprise a target missile.

In one embodiment, said second vehicle 104a can be equipped to emit a broadcast signal 110 and said first vehicle 104b can comprise a signal receiver 112 and a control system 114 for interpreting said broadcast signal 110, as discussed below. In FIGS. 1A-2B, it is assumed that said broadcast signal 110 is emitted from said second vehicle 104a at a known regular frequency. In another embodiment, said broadcast signal 110 can vary and such variance can be interpreted in software to compensate for the irregular signal frequency.

In said stationary diagram 100, neither of said two moving vehicles 104 are moving; consequently, said broadcast signal 110 from said second vehicle 104a will arrive at fixed and unchanging frequencies. In one embodiment, said broadcast signal 110 can be transmitted from a telemetry system in said second vehicle 104a. In one embodiment, said broadcast signal 110 can comprise an encrypted signal, wherein said first vehicle 104b can comprise a system for recording and/or decrypting said broadcast signal 110.

The physical phenomenon occurring during a miss event is introduced in said approaching vehicle diagram 102, said passing vehicle diagram 200 and said departing vehicle diagram 202.

As said two moving vehicles 104 approach and depart from one another, a miss distance 116 comprises a distance between said two moving vehicles 104 at a given time. In said approaching vehicle diagram 102, said miss distance 116 can comprise a first distance 118; in said passing vehicle diagram 200, said miss distance 116 can comprise a minimum distance 204; and in said departing vehicle diagram 202, said miss distance 116 can comprise a second distance 206.

Characteristics of said broadcast signal 110 will change as perceived by said first vehicle 104b, according to the Doppler effect and a received signal strength. This perceived frequency and signal strength will be referred to as a received signal 120. Accordingly, said received signal 120 will change as said two moving vehicles 104 transition between said approaching vehicle diagram 102, said passing vehicle diagram 200 and said departing vehicle diagram 202.

It is noted that with said two moving vehicles 104 not moving, as in said stationary diagram 100, said received signal 120 will be substantially identical to said broadcast signal 110.

As illustrated in said approaching vehicle diagram 102, with said two moving vehicles 104 approaching one another and said miss distance 116 is decreasing, said received signal 120 can comprise an increased frequency above the broadcast frequency and an increasing RSSI as distance decreases.

In one embodiment, said received signal 120 can be measured by said signal receiver 112 and said control system 114 of said first vehicle 104b.

As illustrated said passing vehicle diagram 200, assuming said two moving vehicles 104 do not collide, they will reach said minimum distance 204 where said two moving vehicles 104 are as close as they will be during their relative movement. It can be said that said two moving vehicles 104 reach said minimum distance 204 at a time-minimum-distance 210.

In one embodiment, said received signal 120 with said two moving vehicles 104 at said minimum distance 204, can be substantially identical to said received signal 120 with said two moving vehicles 104 not moving, such as in said stationary diagram 100.

As said two moving vehicles 104 begin to move away from one another, such as said departing vehicle diagram 202, said received signal 120, frequency and RSSI begin to decrease.

One objective of the current system is to measure the efficacy of said second vehicle 104a. Properly measuring said minimum distance 204, relative speed, and efficacy of guidance systems and targeting systems on said second vehicle 104a represents a difficult, and high value, engineering problem.

It is noted that since said two moving vehicles 104 are moving in a three-dimensional space with changing speeds and with dissimilar vectors, interpretation of said received signal 120 can be complex, as discussed herein.

Areas of interest during a miss event are the asymptotic high and low frequencies of said received signal 120 as said two moving vehicles 104 approach and depart, respectively. Also, the characteristics of the curve as the frequencies transition from high to low around said minimum distance 204 at said time-minimum-distance 210.

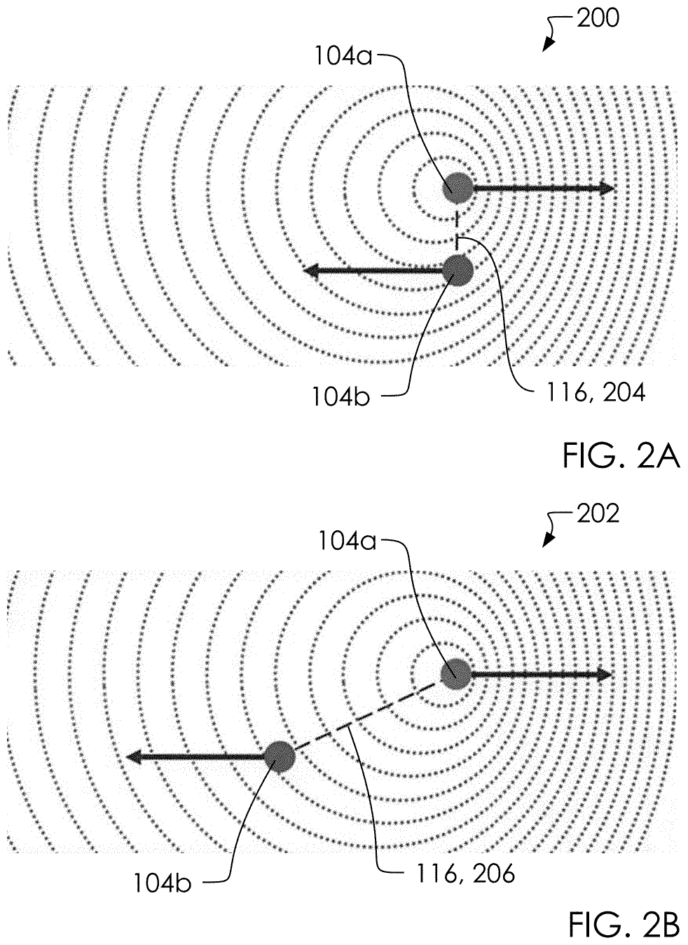

FIGS. 3A, and 3B illustrate a Doppler frequency shift chart 310 and a method of calculating a distance between transmitters and receivers with Doppler signals 300.

In one embodiment, said method of calculating a distance between transmitters and receivers with Doppler signals 300 can comprise: emitting said broadcast signal 110 from said second vehicle 104a; sensing and recording a portion of said broadcast signal 110 with said signal receiver 112 and said control system 114 on said first vehicle 104b; analyzing said received signal 120 over an observation period 302 between a starting time 304, said time-minimum-distance 210 and an ending time 306; calculating a slope characteristic 308 of said received signal 120 over said observation period 302; and calculating said miss distance 116 between said two moving vehicles 104 based on said slope characteristic 308.

In one embodiment, said Doppler frequency shift chart 310 can characterize said received signal 120 as perceived by said first vehicle 104b throughout the relative movement of said two moving vehicles 104. As is taught by the Doppler principles, the frequency of a wave, such as light or sound, will be compressed as said two moving vehicles 104 approach one another and expand as said two moving vehicles 104 depart from one another.

Here, said slope characteristic 308 is expressed as a frequency shift 312. In one embodiment, said frequency shift 312 can be calculated by subtracting a transmitted frequency from said received signal 120, as expressed in fifth equation 500e below. As will be established, said time-minimum-distance 210 can be calculated when said frequency shift 312 equals zero.

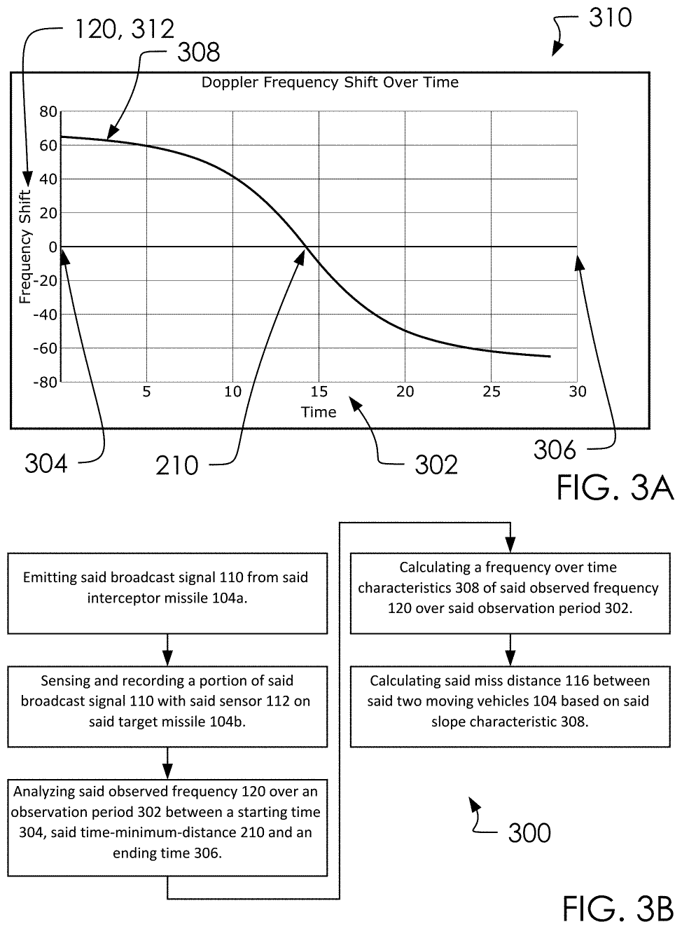

FIG. 4 illustrates a velocity vector illustration 400 of said two moving vehicles 104.

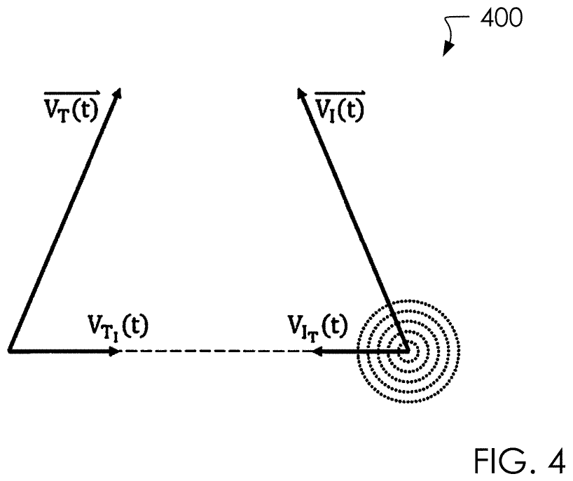

FIGS. 5A, 5B, 5C, 5D, 5E, and 5F illustrate a first equation 500a, a second equation 500b, a third equation 500c, a fourth equation 500d, said fifth equation 500e, and a sixth equation 500f.

In one embodiment, said two moving vehicles 104 can approach one another with arbitrary velocities, and said second vehicle 104a can emit said broadcast signal 110 as RF at a single carrier frequency.

With reference to said velocity vector illustration 400 and said first equation 500a, a closing velocity 504 can comprise the sum of the velocity of each of said two moving vehicles 104 projected toward one another.

According to said second equation 500b, said received signal 120 as observed by said first vehicle 104b can comprise a function of the velocity of each vehicle towards the other, due to doppler shift.

As expressed in said third equation 500c, when the RF propagation velocity is much larger than the interceptor closing velocity component, the difference can be expressed as just the propagation velocity.

As seen in said fourth equation 500d, combining said first equation 500a, said second equation 500b and said third equation 500c, yields an expression for said received signal 120 by the target in terms of just said closing velocity 504.

It is noted that said fourth equation 500d is in terms of just said closing velocity 504 as defined in said first equation 500a. The individual target and interceptor velocities may be anything (one could even be zero), provided the inequality in said third equation 500c remains valid.

Further, as discussed above, said frequency shift 312 can be calculated by subtracting a transmitted frequency 502 from said received signal 120, as shown in said fifth equation 500e.

Finally, said method of calculating a distance between transmitters and receivers with Doppler signals 300 can comprise: calculating said closing velocity 504 using either said transmitted frequency 502 or said received signal 120, as illustrated in said sixth equation 500f. Wherein, said sixth equation 500f can comprise rearranging said fourth equation 500d and said fifth equation 500e.

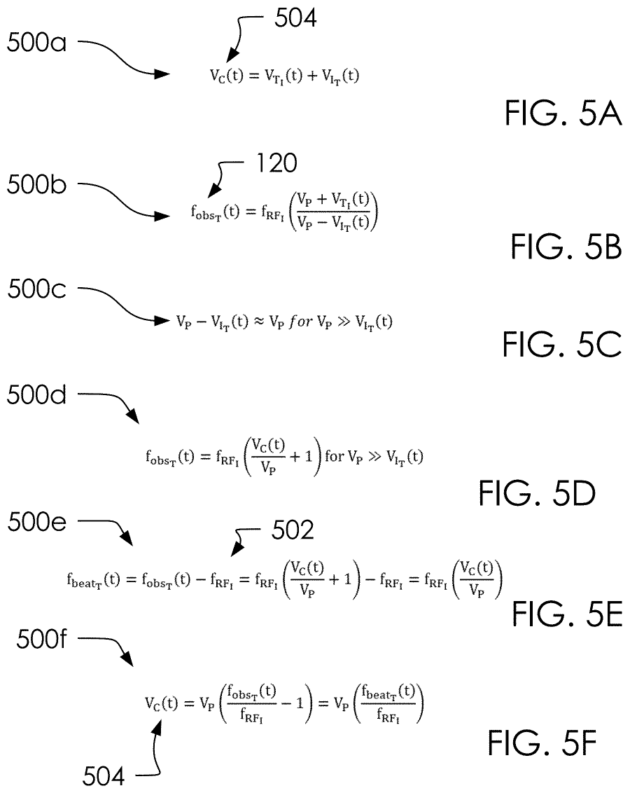

FIG. 6 illustrates a breakdown of the steps for the fourth equation 600.

Note that the final line of said breakdown of the steps for the fourth equation 600 comprises substituting the numerator with said first equation 500a and the denominator with said third equation 500c.

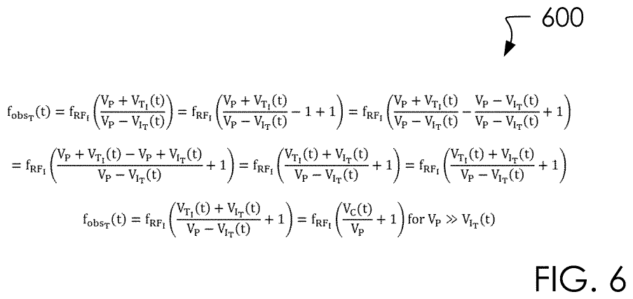

FIGS. 7A-7B illustrate a flyby model illustration 700 and a method of calculating a miss distance using a flyby model 704.

In one embodiment, said method of calculating a distance between transmitters and receivers with Doppler signals 300 can comprise said method of calculating a miss distance using a flyby model 704 for calculating said miss distance 116 given said frequency shift 312 and a propagation velocity 702.

In one embodiment, said method of calculating a miss distance using a flyby model 704 can comprise: determining said starting time 304, comparing said frequency shift 312 captured by said signal receiver 112 to said slope characteristic 308, and modifying initial velocity 806, initial distance 804 and said miss distance 116 using an error minimization optimization techniques.

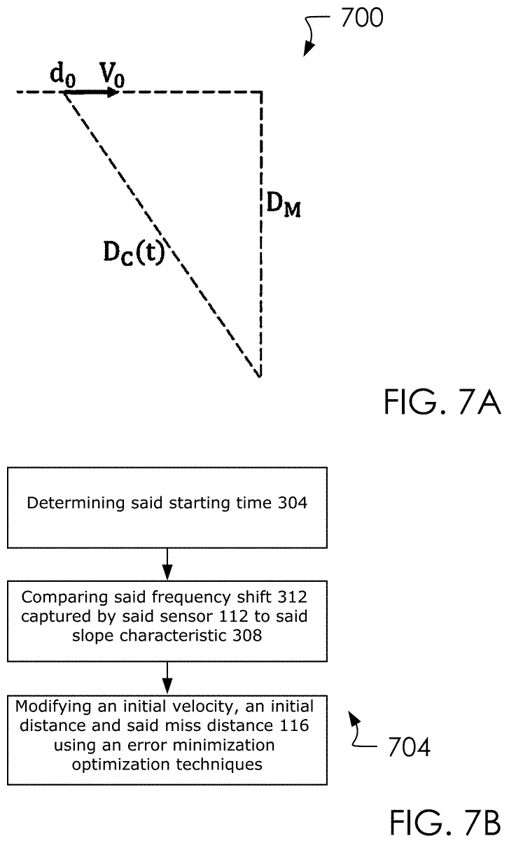

FIGS. 8A, 8B, 8C, and 8D illustrate a seventh equation 800a, an eighth equation 800b, a ninth equation 800c, and a tenth equation 800d.

Said seventh equation 800a calculates a distance along the flight path which said second vehicle 104a has taken. Said eighth equation 800b comprises a calculation of a closing distance 802. Accordingly, said closing velocity 504 can be calculated according to said ninth equation 800c as the time derivative of said closing distance 802.

For these calculations and illustrations, note that a negative sign was dropped in said ninth equation 800c to give said closing velocity 504 a positive value as the vehicles approach, and a negative value as they depart. This is shown in said Doppler frequency shift chart 310 above and in a Doppler frequency shift chart 900 below.

Finally, said tenth equation 800d combines said fifth equation 500e and said ninth equation 800c to give an expression of said frequency shift 312.

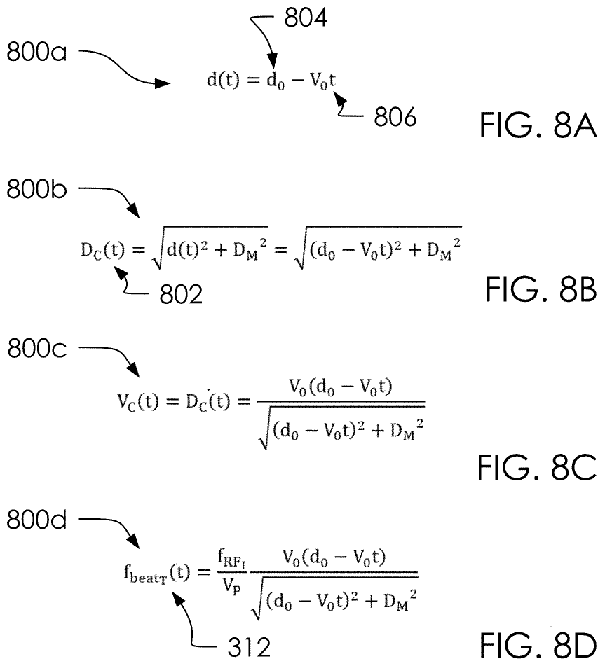

FIG. 9 illustrates said Doppler frequency shift chart 900.

In one embodiment, said tenth equation 800d can be evaluated given a plurality of said slope characteristic 308 for various projectile scenarios and laid out as seen in said Doppler frequency shift chart 900. Wherein, a plurality of curves 904 are seen to express said slope characteristic 308 of said frequency shift 312 over time when said two moving vehicles 104 projectile paths are altered. As shown in said Doppler frequency shift chart 900, said miss distance 116 can have a meaningful change to said slope characteristic 308 where all other parameters are held constant.

Accordingly, said method of calculating a distance between transmitters and receivers with Doppler signals 300 can comprise said method of calculating a miss distance using a flyby model 704 by fitting said tenth equation 800d to data collected by said signal receiver 112, as discussed above.

In one embodiment, said method of calculating a miss distance using a flyby model 704 can comprise optimizing starting values for said initial distance 804 and said initial velocity 806 using an integral model 902, discussed below.

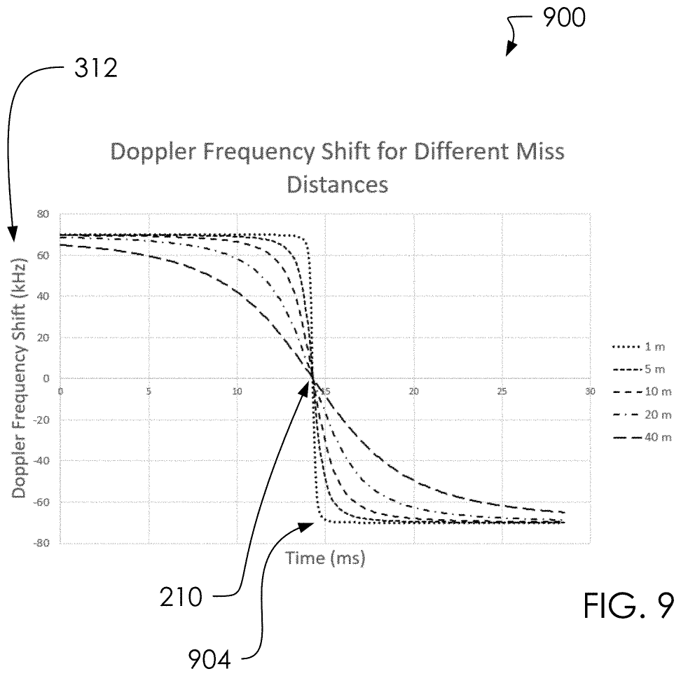

FIGS. 10A, 10B, 10C, 10D, and 10E illustrate an eleventh equation 1000a, a twelfth equation 1000b, a thirteenth equation 1000c, a fourteenth equation 1000d, and a fifteenth equation 1000e.

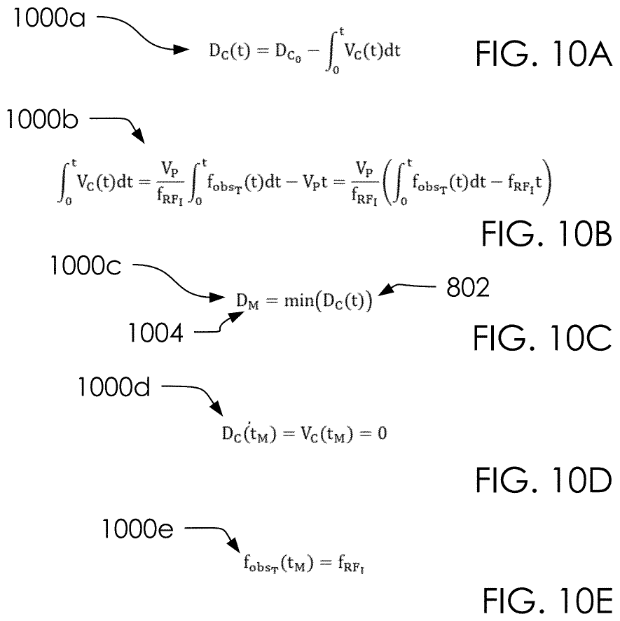

FIGS. 11A, 11B, 11C, 11D, 11E, and 11F illustrate a sixteenth equation 1100a, a seventeenth equation 1100b, an eighteenth equation 1100c, a nineteenth equation 1100d, a twentieth equation 1100e, and a twenty-first equation 1100f.

The equations laid out in FIGS. 10A-11F can describe said integral model 902.

In one embodiment, said method of calculating a distance between transmitters and receivers with Doppler signals 300 can further comprise an integral method of calculating a miss distance 1002, which can supplement said method of calculating a miss distance using a flyby model 704.

Said eleventh equation 1000a can comprise an integration of said closing velocity 504, wherein, the distance traveled between said two moving vehicles 104 can be obtained relative to an arbitrary starting distance. Subtracting the integral of velocity from the starting distance results in the distance between the two vehicles.

Said twelfth equation 1000b comprises the combination of said eleventh equation 1000a and said sixth equation 500f.

Said thirteenth equation 1000c can comprise a scalar miss distance 1004 as the minimum of said closing distance 802.

Said fourteenth equation 1000d can comprise a time of the minimum closing distance which can be obtained by taking the time derivative of said closing distance 802 and finding the time of the zero crossing.

Said fifteenth equation 1000e can comprise a combination of said fourteenth equation 1000d and said sixth equation 500f. Accordingly, the time when said received signal 120 by said first vehicle 104b is equal to said transmitted frequency 502 (which can comprise the RF carrier frequency transmitted by said second vehicle 104a).

Said sixteenth equation 1100a can comprise time of the minimum closing distance is also the inflection point of said closing velocity 504, and by extension said received signal 120. This is the time of the zero crossing of the second time derivative.

For said seventeenth equation 1100b, assume that the trajectories of said two moving vehicles 104 are linear over the observed range, their velocities are not time varying, and the initial distance is much larger than the miss distance. Thereby, said seventeenth equation 1100b resolves that said initial distance 804 can be linearly estimated from an initial closing velocity 1102 of said closing velocity 504.

Said eighteenth equation 1100c can comprise calculating said initial closing velocity 1102 using said sixth equation 500f at time=0.

Said nineteenth equation 1100d can comprise combining said eleventh equation 1000a, said twelfth equation 1000b and said eighteenth equation 1100c. And said twentieth equation 1100e can comprise combining said fifteenth equation 1000e and said nineteenth equation 1100d.

Finally, said twenty-first equation 1100f can comprise said twentieth equation 1100e at the time of the minimum of said closing distance 802, which yields the value of said scalar miss distance 1004.

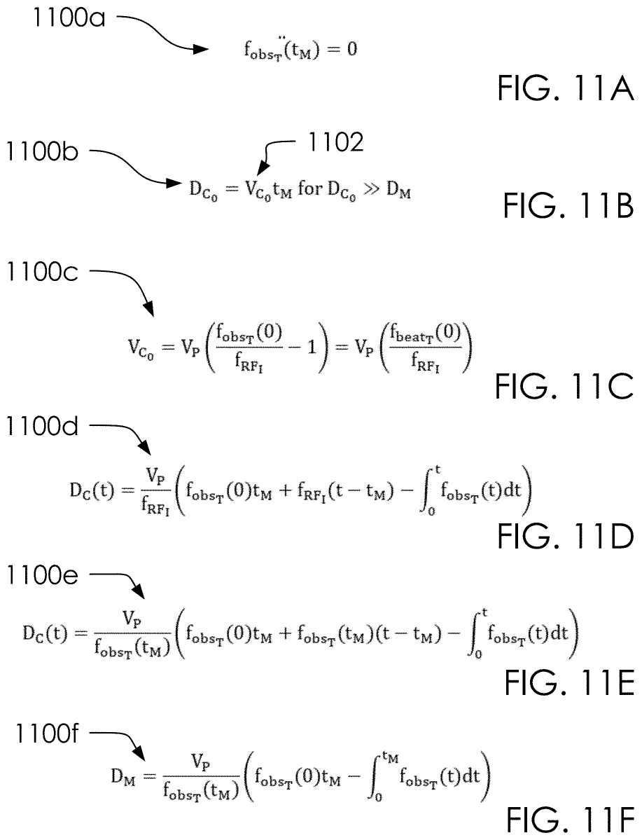

FIGS. 12A, 12B, 12C, 12D, 12E, and 12F illustrate a twenty-second equation 1200a, a twenty-third equation 1200b, a twenty-fourth equation 1200c, a twenty-fifth equation 1200d, a twenty-sixth equation 1200e, and a twenty-seventh equation 1200f.

Determining the nature of said broadcast signal 110 can be assessed by first considering the nature of said frequency shift 312. Said twenty-second equation 1200a illustrates that the maximum and minimum frequency shifts are always equal in magnitude and opposite in sign. Wherein, the maximum of said frequency shift 312 is positive for an intercept attempt.

Thereafter, said twenty-third equation 1200b, said twenty-fourth equation 1200c and said twenty-fifth equation 1200d illustrate that a frequency range 1202 of a doppler profile is the difference between the max and min of said frequency shift 312, which is also twice the max of said frequency shift 312.

Knowing said frequency range 1202, a design parameter of said signal receiver 112 can be modified to ensure that the bandwidth of said broadcast signal 110 from a transmitter of said second vehicle 104a. Wherein, the system must be sensitive enough to be able to discriminate said frequency range 1202 in the presence of all other sources of frequency uncertainty (clock drift, etc.).

Finally, generating said broadcast signal 110 using a carrier frequency can be expressed as a sine wave as shown in said twenty-sixth equation 1200e, as derived from said tenth equation 800d which gives said frequency shift 312 as a function of said transmitted frequency 502, relative velocity, distances and time.

Said twenty-seventh equation 1200f can comprise combining said tenth equation 800d and said twenty-sixth equation 1200e.

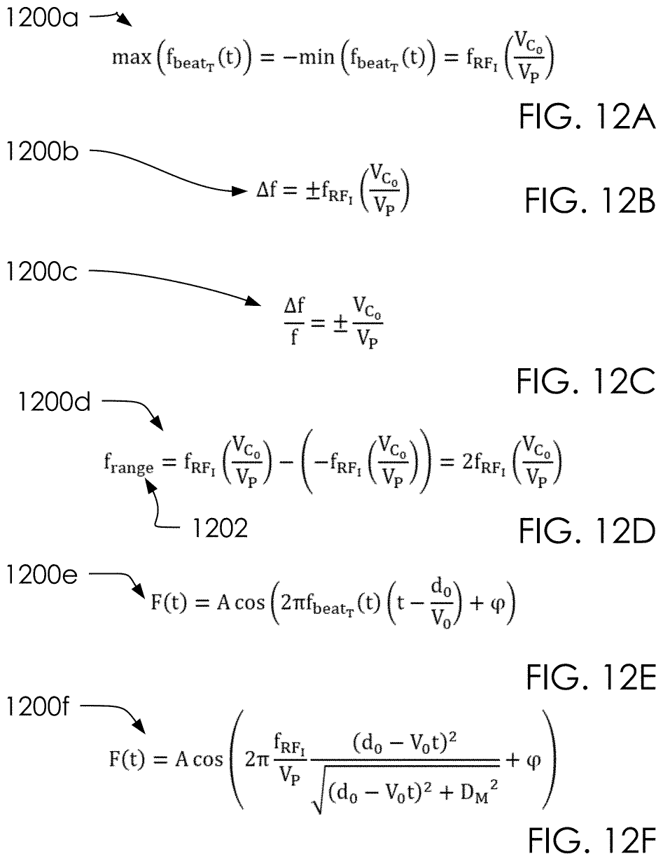

FIGS. 13A, and 13B illustrate an ideal method 1300 and a practical method 1302 of determining said miss distance 116.

In one embodiment, said method of calculating a distance between transmitters and receivers with Doppler signals 300 can comprise said ideal method 1300 provided the given of said received signal 120 and said propagation velocity 702, comprising: determining said starting time 304 with all other times in said observation period 302 must reference said starting time 304; determining said time-minimum-distance 210 by finding an inflection point in said received signal 120 according to said sixteenth equation 1100a; and evaluating said twenty-first equation 1100f with said time-minimum-distance 210.

In one embodiment, said method of calculating a distance between transmitters and receivers with Doppler signals 300 can comprise said practical method 1302 provided the given of said received signal 120, said propagation velocity 702, and an actual interceptor frequency 1304, comprising: determining said starting time 304 with all other times in said observation period 302 referencing said starting time 304; determining an interceptor frequency 1306 from said received signal 120 at said time-minimum-distance 210; corroborate said interceptor frequency 1306 with the claimed said actual interceptor frequency 1304 according to said sixteenth equation 1100a; determining said time-minimum-distance 210 by finding an inflection point in said received signal 120 and comparing to said actual interceptor frequency 1304 according to said fifteenth equation 1000e and said sixteenth equation 1100a; corroborating with additional flight information, and evaluating said nineteenth equation 1100d with said time-minimum-distance 210 and said interceptor frequency 1306.

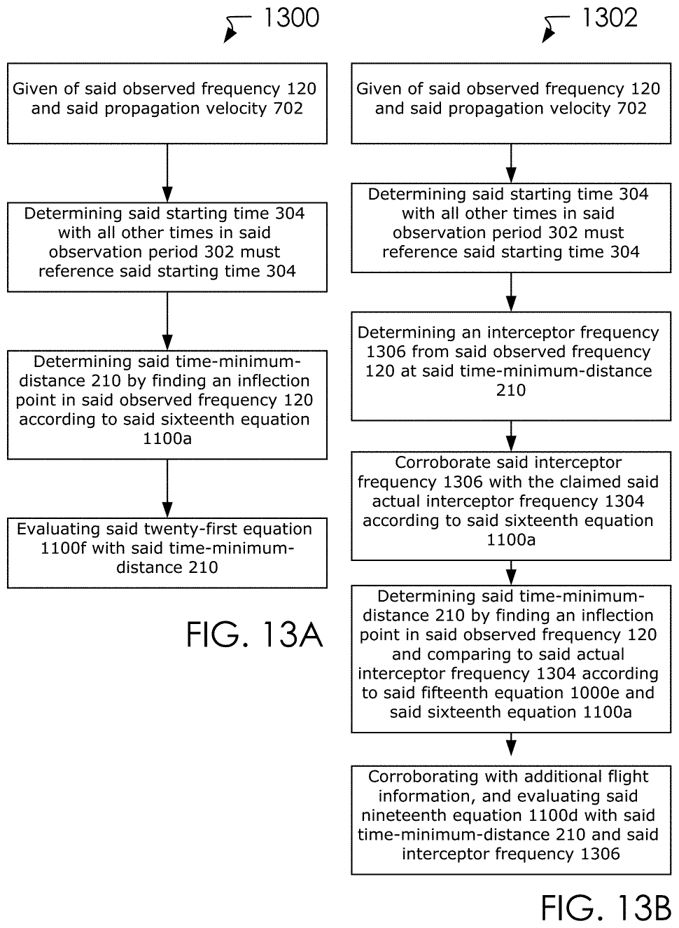

This disclosure now turns to a description of another approach to it goals in the following description of FIGS. 14-34B. Parts of this new approach are introduced in the background section of this application and as described below in the “Scenario Terminology”.

FIG. 14 illustrates a diagram of said two moving vehicles 104 with said broadcast signal 110 moving relative to said broadcast signal 110 along a transmitter path 1400.

In one embodiment, FIG. 14 can comprise a transmitter 1402 of said broadcast signal 110, a telemetry signal, which can travel along said transmitter path 1400 which can comprise a straight-line path. Further, for analysis, said transmitter 1402 can move at constant speed.

One goal of this investigation is to determine a means by which measured RSSI and Doppler frequency shift of an incoming carrier can be used to estimate said miss distance 116 between said two moving vehicles 104.

In one embodiment, to achieving this goal is to determine a means by which the Doppler frequency impressed upon a received signal (such as said received signal 120) by relative motion between said transmitter 1402 and said signal receiver 112 (that is, transmitter and receiver) can be estimated. More specifically, said transmitter 1402 is providing an RF signal modulated with telemetry data.

One goal in dealing with this type of signal would be to remove any carrier offset and Doppler components of the signal to accurately recover the modulated data. In this effort, the data is of no interest. The received signal strength will be estimated using a Received Signal Strength Indicator (RSSI) technique and the Doppler frequency shift will be estimated using the techniques presented herein and as known in the art.

In one embodiment, said method of calculating a distance between transmitters and receivers with Doppler signals 300 can comprise: capturing a Received Signal Strength Indicator (RSSI) signals, capturing a change in a Doppler frequency shift of said broadcast signal 110, estimating a received signal strength using a common Received Signal Strength Indicator (RSSI) technique, and estimating the Doppler frequency shift.

Scenario Terminology

A receiver is located along, and adjacent to, said transmitter path 1400. This scenario will be referred to as an encounter. There are no objects near the path to cause multipath interference. RSSI and Doppler estimation is to be performed to estimate the closest distance between the receiver and the transmitter path.

The point of closest passage in an encounter will be referred to in this document as the epoch, also said time-minimum-distance 210. As said transmitter 1402 travels in the direction of the epoch, it will be described as approaching. Moving away from the epoch will be described as departing. RSSI will be increasing and Doppler will be positive when approaching, RSSI will be decreasing and Doppler will be negative when departing. Uniquely, RSSI will be maximum and Doppler will be zero at the epoch.

Received Signal Strength

In one embodiment, capturing said received signal 120 as said transmitter 1402 traverses said transmitter path 1400 can be expressed, as labeled in FIG. 14, as r(t-te) where to comprises the time of the epoch (that is, said time-minimum-distance 210).

In one embodiment, said transmitter 1402 can output a carrier signal of constant power including the modulation impressed upon it. The only changes in the general characteristics of said received signal 120 can comprise: (1) a signal strength due to the changing distance between said transmitter 1402 and said signal receiver 112, the path loss; (2) a signal strength due to the beam pattern shapes of transmit and receive antennas; and (3) a doppler frequency shift as said transmitter 1402 moves from approaching to departing.

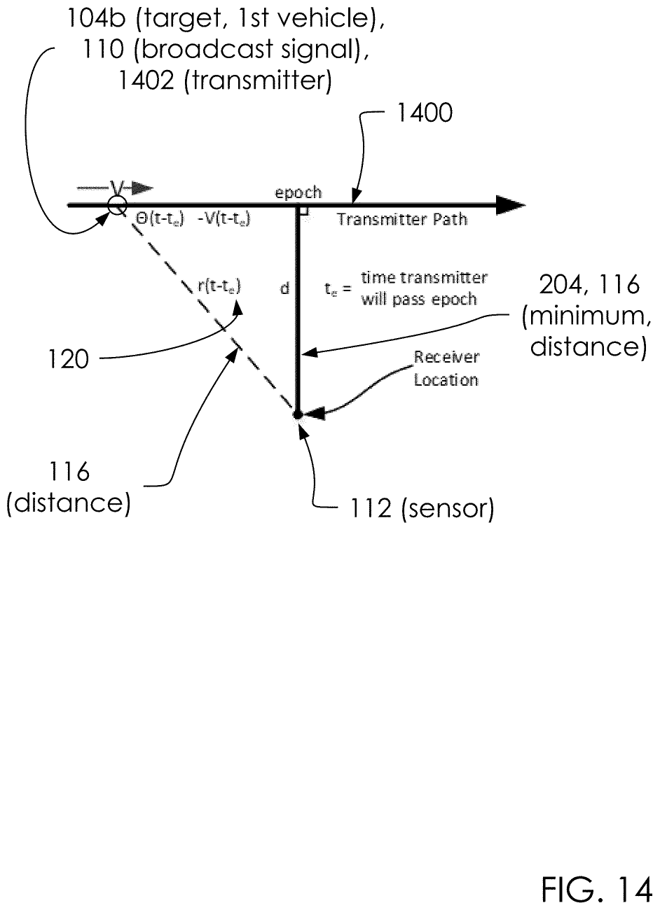

FIG. 15 illustrates an example of the factors between a transmitter and a receiver in a comparison table 1500.

Link Budget

A tabulation of all factors having influence on a strength of said received signal 120 of a communication link under a specific set of conditions are tabulated in a Link Budget. An example of the factors between said transmitter 1402 and said signal receiver 112 are shown in FIG. 15. The format shown displays factors that add to the power of the received signal and a separate column for factors that reduce the received power. All values are in units of dB or dBm.

The important noticeable factors that affect the final received power are the fixed transmit power, antenna pointing losses and the free space loss. The only two factors that change during flight are the pointing losses and the free space loss. No other factors change as a result of the spatial relationship modifications during the encounter.

Free space path loss and antenna pointing losses are discussed in the next subsections, respectively.

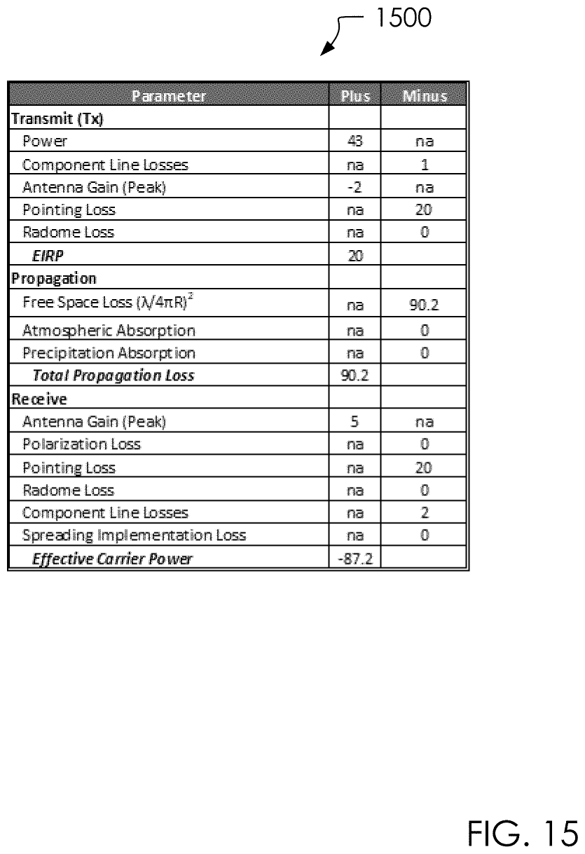

FIG. 16 illustrates a formula.

Free Space Path Loss

Free space path loss occurs due to the spherical spreading of the available power from an isotropic antenna. This loss of RF power in a free space environment is characterized by the following equation, also shown in FIG. 16.

P_r/P_t=(c/4πfr)\hat{ }2

For FIG. 16, assume Pr is the receive power, Pt is the transmit power, c is the speed of propagation (speed of light), f is the carrier frequency and r is the range between antennas.

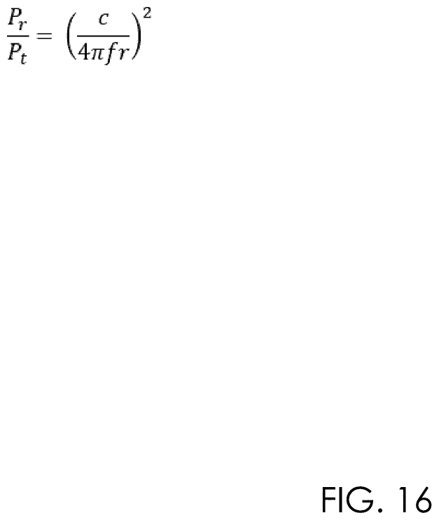

FIGS. 17A, and 17B illustrate an S-Band antenna beam pattern and a graph.

Antenna Pointing Loss

The beam shape of the antenna causes more power to be radiated in some directions and less in others from the antenna. The same effect is observed in a receive antenna. This effect is noted in the antenna pointing losses shown in FIG. 16.

First, FIG. 17A shows an S-Band antenna beam pattern designed for telemetry use where it would be attached to the side of a rocket. A second antenna would be attached to the opposite side of the rocket to ensure RF coverage in all directions around the rocket body. Whereas the design objective is to provide uniform signal gain over a 180° sector by each antenna, that is not achieved in practice. The result is a tapering of the antenna gain away from boresight and a rapid drop as ±90° is approached. This is the antenna beam pattern that is used for both the transmit and receive antennas in the examples throughout this report.

The scenario permits evaluation of two important link budget conditions: large separation, and adjacent miss distance separation. The maximum range of the Miss Distance Indicator system can be estimated when said transmitter 1402 and said signal receiver 112 are at a large distance from each other. The maximum received signal strength can be estimated when said transmitter 1402 and said signal receiver 112 are adjacent to each other.

These two scenario moments are shown graphically in FIG. 17B. Obviously, there is a significant difference in free space loss between the two transmitter positions due to the large difference in separation. Further, in this example, both antennas are using the same beam pattern that causes the total pointing loss to be double that of a single antenna. The pointing loss of each antenna is particularly large because both antennas are communicating near 90° and far from their boresight until the epoch is near. During the near miss the antenna beam patterns are effectively swept, transmitter from 90° to −90° and receiver from −90° to 90°. This is worst case because a rotation of the target would prove beneficial to the receive antenna.

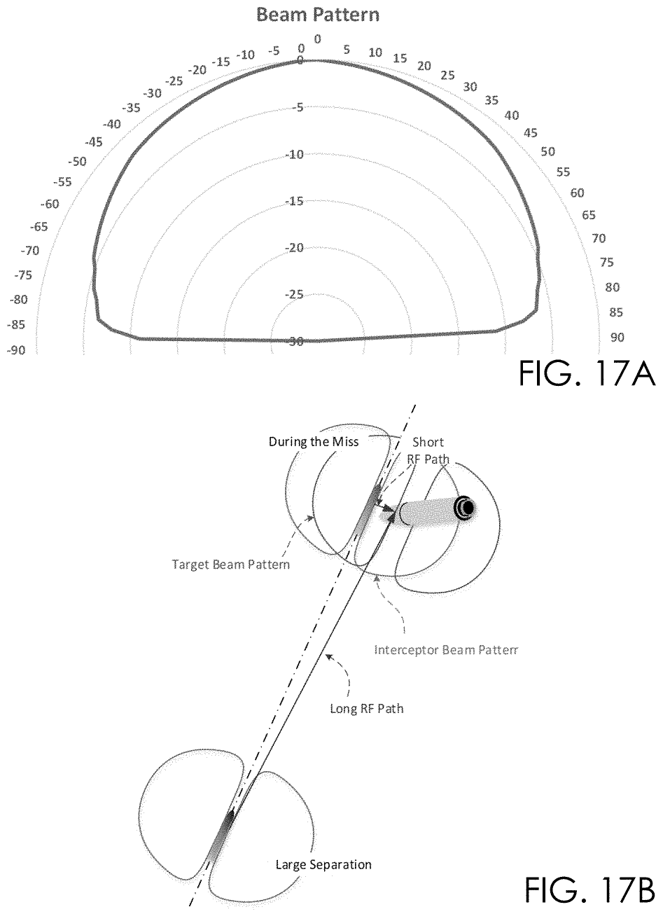

FIGS. 18A, and 18B illustrate a table and chart.

First, FIG. 18A indicates a difference from −87.2 to −2.3 dBm of dynamic range would be required to handle these two scenario moments linearly and this would have hardware consequences. The ranges of the transmitter from the epoch in this example are 350 meters and 2 meters. There is a 45 dB difference in free space loss and a 40 dB difference in antenna pointing loss.

The RSSI before, during and after the miss is shown in FIG. 18B for a range of miss distances from 2 to 80 meters. This figure clearly shows the potential of RSSI as an effective information source for near misses because of its differentiation ability from, say 2 to 10 meters versus 40 to 80 meters.

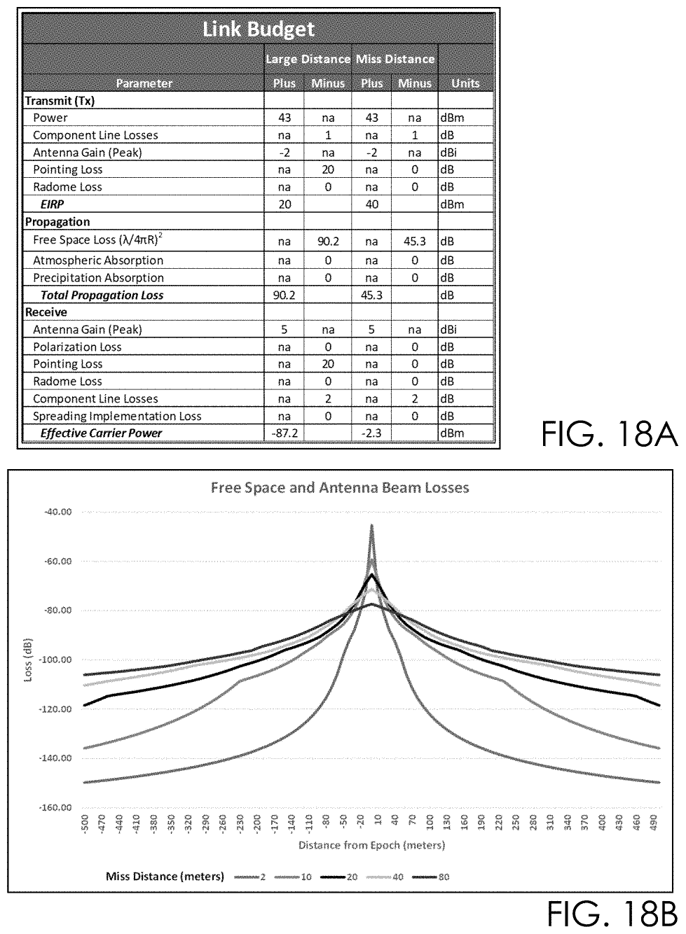

FIGS. 19A and 19B illustrate an RF transmitter moving through space at a speed V 1904 and equation 1900.

Doppler Frequency Estimation

Doppler Frequency Range

On a near miss path, said transmitter 1402 approaches, then departs, said signal receiver 112. A straight-line path (such as said transmitter path 1400) and a point define a plane enabling this three-dimensional problem to be viewed in two dimensions. Doppler frequency varies as a function of the relative velocity between said transmitter 1402 and said signal receiver 112.

Assume an RF transmitter is moving through space at said speed V 1904 on said transmitter path 1400 as shown in FIG. 19A. wherein, said signal receiver 112 at a time varying approach angle 1906 (labeled “θ(t)”) from said transmitter path 1400 at time t. The Doppler frequency shift of the transmitter's carrier frequency depends on said speed V 1904 and said time varying approach angle 1906 of said transmitter 1402 relative to said signal receiver 112. This is depicted in exaggerated form as circles of wave peaks emanating at successive transmitter locations along the path. Said equation 1900 for the instantaneous Doppler shift observed at the receiver can be written as shown in FIG. 19B.

With reference to said equation 1900 illustrated in FIG. 19B, fd(t) is the time-varying observed instantaneous Doppler frequency shift and c is the speed of light.

Bounding fc can be accomplished by using the minimum and maximum frequencies of popular RF telemetry spectrum bands. A reasonable speed for said speed V 1904 would be 7 km/s. A reasonable maximum speed for said speed V 1904 would be 30 km/s. Speed of light will be approximated as 300,000 km/s.

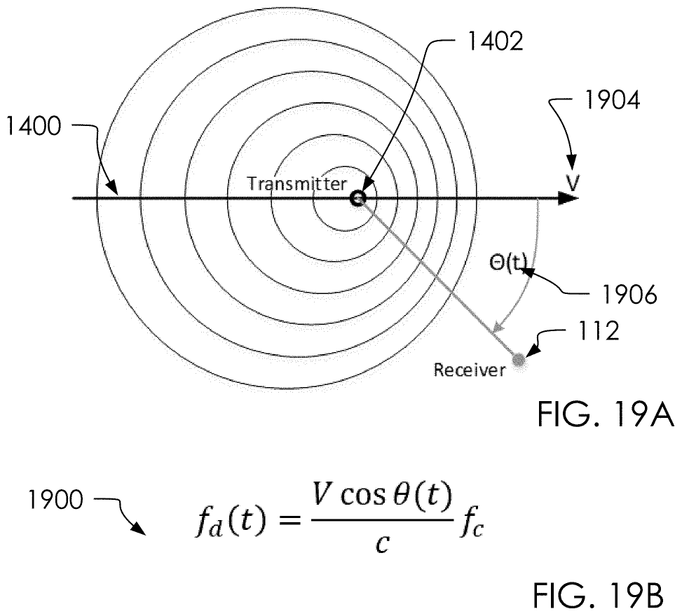

At the current time, it is expected that the range of practical fc frequencies for telemetry would be no less than 1435 nor more than 2390 MHz encompassing the Lower-L through the Upper-S bands as shown in table 2002 of FIG. 20B. Also shown in the Table is the maximum positive (approaching) or negative (departing) Doppler frequency shift expected at various carrier frequencies throughout these bands.

FIGS. 20A and 20B illustrate probability density functions 2000 for said transmitter 1402 and said signal receiver 112 and said table 2002.

Said probability density functions 2000 comprises describing the randomness of the clocks and, thereby, the carrier frequency random offsets due to component variations.

Carrier frequency offset refers to the difference in carrier frequencies between said transmitter 1402 and said signal receiver 112. Carrier frequency inaccuracy is specifically limited by IRIG 106 to (±0.002%)±20 ppm for transmitters and (±0.001%)±10 ppm for receivers. It is a function of the clocks in said transmitter 1402 and said signal receiver 112 and is a constant frequency difference throughout an encounter. This offset is removed along with Doppler in the normal receiver process of demodulating the signal and decoding the bits. This removal will not be performed in this application. The carrier inaccuracy will be a constant bias in the estimation of Doppler frequency offset. A clock frequency at the receiver that is slower than the clock at said transmitter 1402 will make frequencies appear higher and bit timing appear faster when measured at said signal receiver 112.

Wherein, FIG. 20 illustrates the probability density functions for receivers and transmitters assuming worst case crystal selection by measurement (results in equally-likely density function) along with the resulting probability density for their difference determined by density function convolution.

Said table 2002 shows the range of carrier frequency offset due to clock differences at each sub-band using a 30-ppm combined clock difference as very unlikely worst cases. It may be possible to reduce the 10 ppm by crystal selection and tuning.

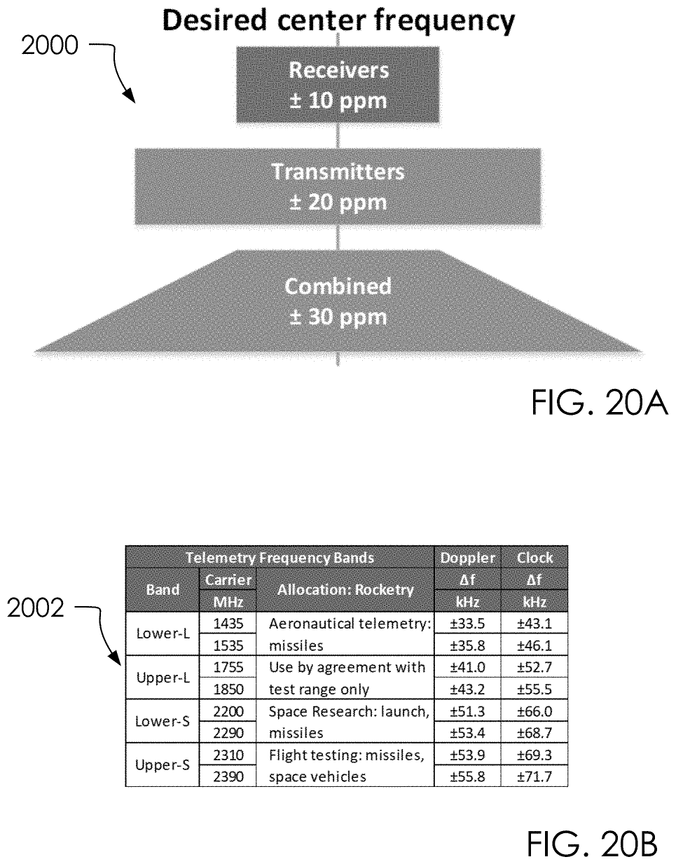

FIG. 21 illustrates a plurality of formulas related to signal modeling.

To communicate, said transmitter 1402 and said signal receiver 112 can be tuned to what is expected to be the same frequency. However, small differences in internal crystals can cause the resulting signal frequencies to reflect these clock differences. In the following discussions, the frequency resulted from said transmitter 1402 when trying to generate frequency, f, will be denoted by ft and that by said signal receiver 112 will be denoted by fr.

A signal, S(t), includes a carrier at frequency ft, a modulation signal, ϕ(t) and an arbitrary and unknown constant initial phase, φ. The signal sent to the antenna, represented as an ideal analytic signal, is an equation 2102

This radiated signal will be modified due to a moving transmitter by an instantaneous Doppler frequency shift that depends on the time-varying angle from travel path to receiver. See an equation 2104.

The signal input to the receiver, R(t), will have this identical form because, for this ideal exercise, channel and other signal impairments are being ignored.

The quadrature sinusoids generated at the receiver can be represented an equation 2106 where * denotes complex conjugate.

The demodulated I and Q signals become the real and imaginary parts of the product of R(t)Q*(t) in an equation 2108.

The instantaneous phase of the demodulated, received signal is simply the exponent, p(t) in an equation 2110.

It is common to use the phase change, Δp(t_1,t_2), as a means of removing the unknown absolute phase difference, φ. The time parameters are separated by the parameter, Δt, that could represent the reciprocal of the digital sampling rate, the symbol rate, or any other time difference. Thus, Δt=t_2−t_1 in an equation 2112.

When said transmitter 1402 and said signal receiver 112 are separated by a large range with transmitter approaching then θ(t) can reasonably be assumed constant and the Doppler frequency will be constant so that f_d(t_2)=f_d(t_1) and both can be replaced by fmax for some range of the time differences. Using this assumption and defining Δf=f_t−f_r, the equation for phase change can be simplified in an equation 2114.

Replacing t_1 with t and t_2 with t+Δt, then the differential phase can be written as Δp(t,Δt) in an equation 2116.

If N samples of Δp(t,Δt) taken at a rate of f_s=1/Δt samples per second are averaged, the result is as shown in a three equations 2118.

Using these definitions, the equation for average phase difference can be written as an equation 2122. Wherein, the terms 2πΔf and 2πf_max are constants as long as the range is appropriately large. The modulation term depends only on the modulation phase differences at the beginning and end of the N sample window.

Since, with any of the modulations being considered, the maximum phase difference is ±π radians, the maximum contribution of the phase difference term is bounded by ±2π/N. As a result, an estimate of Z(t,Δt,N) can be determined with the characteristics in two equations 2124.

Now a biased estimate of the maximum Doppler can be written as an equation 2126.

The bias in this estimate is Δf, the unknown difference in frequency between said transmitter 1402 and said signal receiver 112.

The estimate error is due to modulation, is bounded and can be controlled by adjusting the number of samples, N in an equation 2128. But Δt is the time between samples used to compute phase differences and N is the number of samples. Their product is simply the sample window size, T=ΔtN. The final bound becomes the reciprocal of the data window size.

This estimate of maximum Doppler frequency, although biased, is free from modulation type. An algorithm to compute this estimate can be recursive allowing its accuracy to increase as N becomes larger.

After the epoch it becomes possible to estimate the bias term because the sign of the Doppler frequency reverses. Let t\hat{ }− represent time well before the epoch and t\hat{ }+ represent time well after the epoch where Doppler is expected to be stable. The sum between Z\hat{ }(t\hat{ }−,Δt,N) and Z\hat{ }(t\hat{ }±,Δt,N) can be expressed as 2π(f_max+Δf)+2π(−f_max+Δf)=4πΔf. Thus, an estimate of carrier frequency difference can be formulated in an equation 2130. Wherein (Δf)\hat{ } can be used to eliminate the bias in the Doppler frequency estimates.

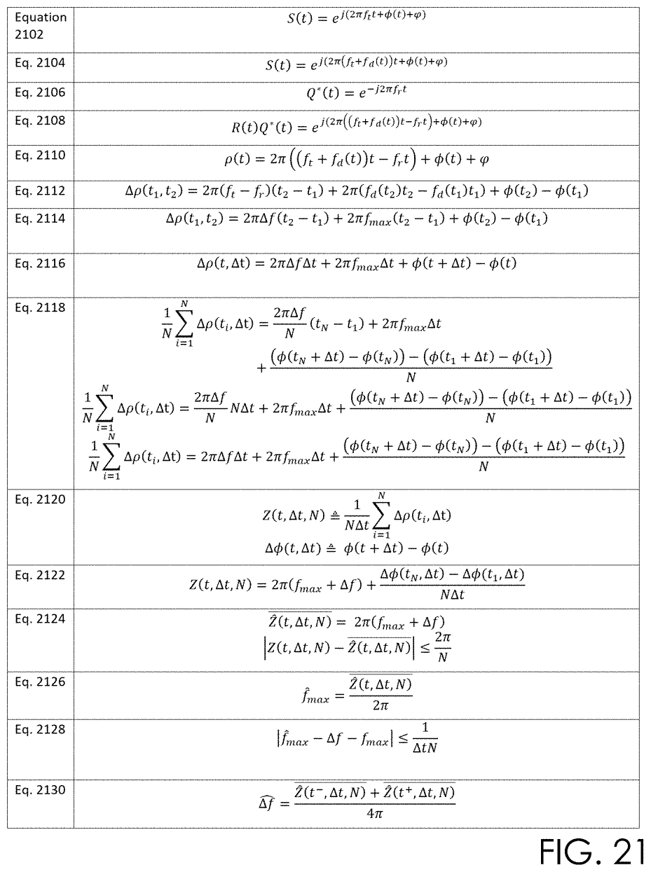

FIG. 22 illustrates a plurality of equations related to phase difference estimation.

Estimation of the phase angle between consecutive samples forms the basis for estimation of Doppler frequency as shown in an equation 2202.

A very reasonable assumption is that the change in Doppler frequency and modulation over the short time, Δt, is zero making it possible to modify said equation 2202 as shown in an equation 2204.

Thus, the estimation of Doppler (plus carrier frequency offset) is directly linked to the estimation of the phase difference between successive samples of the incoming data.

The ith incoming sample can be represented as a two-dimensional vector or a complex number as S_i=I_i+jQ_i where j=√(−1) or a phasor of the form S_i=[Ae]\hat{ }(jp_i). Both forms will be used in the development of equations to estimate phase difference and all vectors will be scaled by their measured power to lie on the unit circle so that I_i\hat{ }2+Q_i\hat{ }2=1 and A=1.

A two equations 2206 demonstrate a vector can be created with unit magnitude by multiplication.

The real part of this multiplication is I_i I_(i+1)+Q_i Q_(i+1) and the imaginary part is I_i Q_(i+1)−I_(i+1) Q_i. Since the magnitudes have been assumed to be scaled to unity, the magnitude of the product is also unity and a two relationships 2208 can be written, each providing a means to compute the angle between the two consecutive samples.

Either of these two relationships can be used to compute Δp_i. The choice of relationship depends on the expected size of Δp_i and that depends on the relationship between sampling rate and incoming frequency. If Δp_i is expected to be 45° or larger then the cosine equation would be most linear and expected to give the more computationally accurate solution. If 45° or less then the sine equation would be operating in the more linear range and would be preferred.

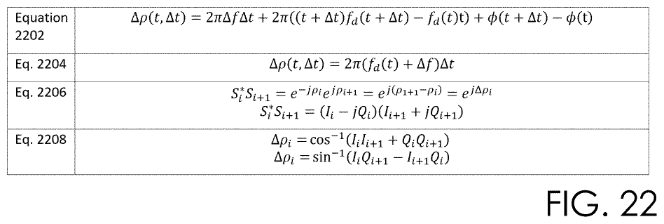

FIGS. 23A, 23B, and 23C respectively illustrate a miss scenario 2310, a plurality of equations, and the Doppler frequency versus time for various miss distances (7 km/s) and no carrier frequency offset.

In said miss scenario 2310 several distances are defined graphically. Functions are related to the time the transmitter passes the epoch, te. The distance from the transmitter to the epoch is defined as −V(t−te) where the negative sign forces the distance to be positive for t<t_e. Distance between said transmitter 1402 and said signal receiver 112 can then be expressed by the Pythagorean Theorem as an equation 2302 which renders the conclusion of an equation 2304.

Thereafter, the Doppler shift can be expressed as illustrated in a two equations 2306.

When |(t−t_e)| is large enough that d2 becomes insignificant relative to (−V(t−t_e))2, then the Doppler asymptotes are horizontal lines with vertical values as shown in an equation 2308.

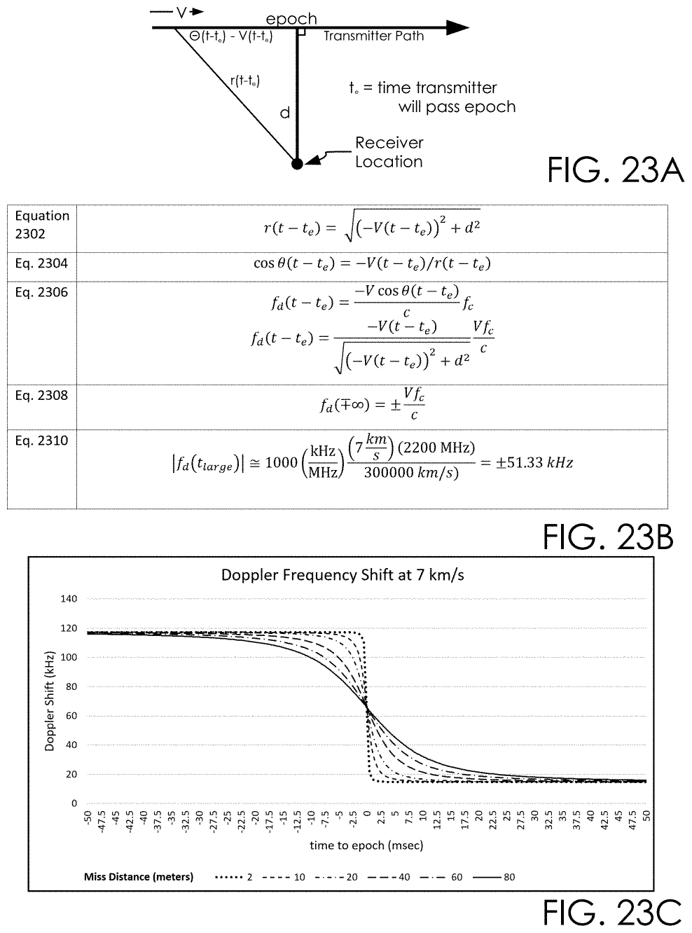

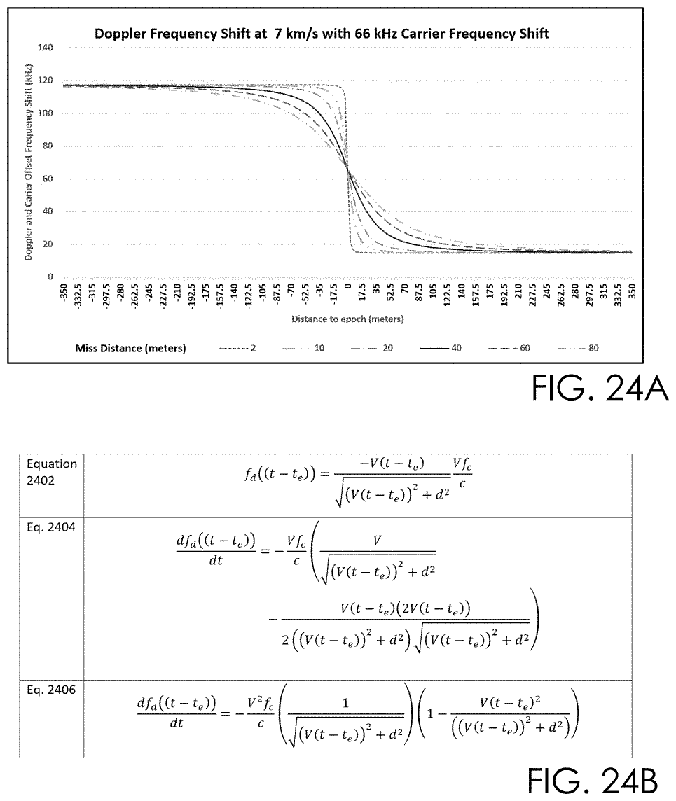

FIG. 24A illustrates the Doppler frequency versus time for various miss distances (7 km/s) and 66 kHz carrier frequency offset.

Epoch Detection

Detection of an epoch assumes that the transmitter actually misses the receiver and no damage occurs to either device. Should this not be the case, post processing must operate on available data to curve fit and infer the miss distance from sets of curves like FIG. 23C and FIG. 24A.

The following are known facts about the problem of epoch detection. First, if the transmitter clock is faster (slower) than the receiver clock then the effect will be to increase (decrease) the apparent received signal frequencies at the receiver. Second, if the transmitter is approaching (departing) the receiver then the effect will be to increase (decrease) the apparent received signal frequencies at the receiver by the Doppler frequency. Third, at a distance beyond which the Doppler appears constant, these two effects are additive constants, inseparable. Fourth, through the encounter, the Doppler frequency component will lower, pass through 0 Hz (Doppler) and then go negative. And fifth, through the encounter, the carrier frequency difference component will not change.

These facts imply that the Doppler and carrier frequency difference can be separated only after data is available both before and after the epoch and, therefore, not in real time. That being the case, Doppler estimates cannot be reliably made until sufficient data is available to estimate the carrier frequency difference. Doppler estimates can be made in advance of the epoch, but they will contain this carrier offset effect.

The shape of the curves in FIG. 23C show a transition from positive to negative Doppler at the time of the epoch. The curves in this example do not include the impact of any carrier frequency offset. This offset can be bounded as shown in the table in FIG. 20B and is a constant that will bias the curves in FIG. 23C either up or down as shown in the example of FIG. 24A. It is possible, though improbable, that the carrier offset is greater than the Doppler forcing the curves in the figure to be completely positive or negative. Detecting the epoch using a change of sign in the estimated Doppler data would be inaccurate at best and may miss the epoch entirely.

One method for removing a constant from a curve is through differentiation. Considering the curves in FIG. 23C, the slope of these curves is near zero at distances where the Doppler frequency is near constant and peaks at the epoch. The change of Doppler frequency shift with time can be derived by repeating the formula for Doppler frequency above and manipulating it illustrated in an equation 2402.

FIG. 24B a plurality of equations related to epoch detection.

Wherein, as illustrated in FIG. 24B, differentiating said equation 2402 with respect to t renders an equation 2404. And rearranging terms results in an equation 2406.

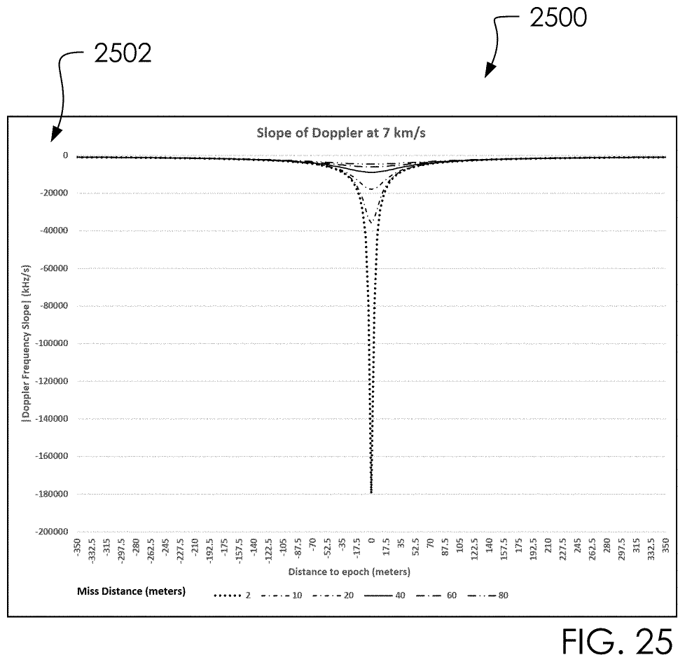

FIG. 25 illustrates a Slope of Doppler Estimates chart 2500.

Said Slope of Doppler Estimates chart 2500 illustrates a slope 2502 at 7 km/s. Said slope 2502 is shown plotted in FIG. 25 for a selection of epoch distances. These curves do not have any contribution from carrier frequency difference whether it is present in the incoming signal data or not. Said slope 2502 is clearly positive post epoch and suggests that a positive slope of the Doppler slope would be a reliable epoch detection algorithm that would be unaffected by any carrier frequency offset in the received signal.

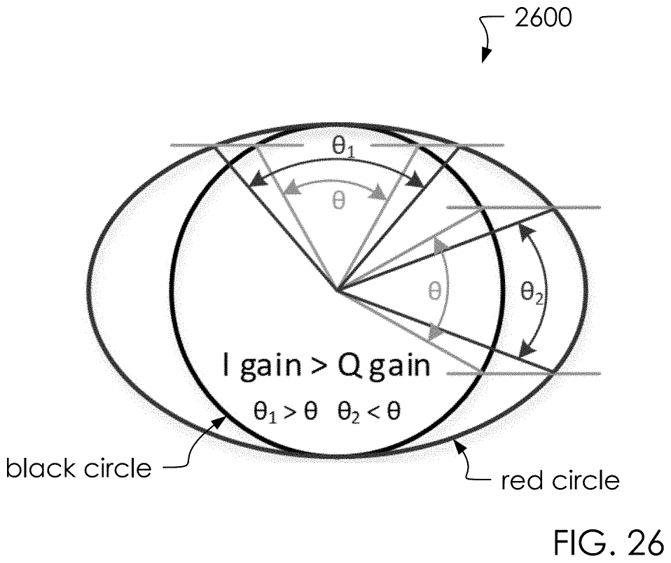

FIG. 26 illustrates an exaggerated example of I/Q imbalance chart 2600.

Impairments

I/Q Imbalance

There will be an imbalance of channel gain of I versus Q somewhere between the transmitter and the receiver. All (I, Q) samples exiting the receiver will ideally have the same magnitude and the vectors representing these samples will lie on a common circle. FIG. 26 illustrates the effect of unequal gains in the I and Q channels. Whereas a rotating phasor would ideally follow the black circle, a higher gain in the I channel causes the phasor to follow the red ellipse. The resulting effect is to introduce a frequency component that is twice the frequency of the incoming phasor.

I/Q imbalance is corrected by putting a sinusoidal signal into the RF front end and adjusting the channel gains until the maximum I and the maximum Q are equal. An I versus Q plot will then result in a circle.

Variable Magnitude Samples

Not all of these modulation schemes adhere to the common magnitude goal because of the Intersymbol Interference (ISI) that they purposely introduce. The effect on any incoming phasor is to introduce a wandering about the circle in FIG. 26. It is expected that the magnitude of each sample will need to be normalized.

Modulation

Modulation schemes of interest in telemetry include: PCM/FM (Pulse Code Modulation/Frequency Modulation) also referred to as CPFSK (Continuous Phase Frequency Shift Keying), SOQPSK (Shaped Offset Quadrature Phase Shift Keying), and SOQPSK-TG (Shaped Offset Quadrature Phase Shift Keying—Telemetry Group).

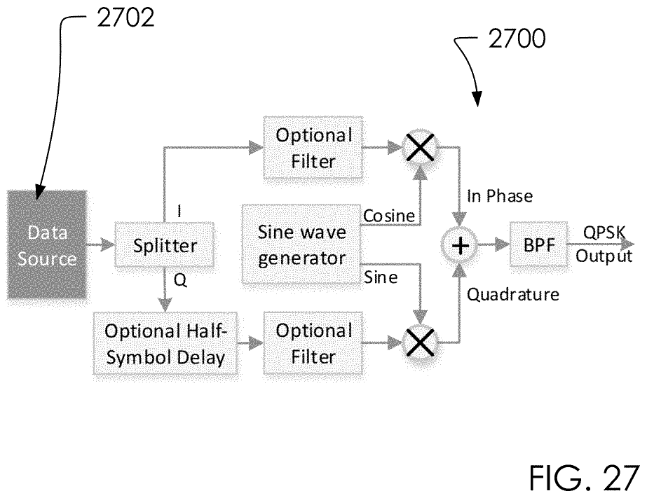

FIG. 27 illustrates a general QPSK modulator block diagram 2700.

QPSK Modulation Methods

With reference to said general QPSK modulator block diagram 2700, a data source 2702 can comprise the raw data to be communicated, forward error correction coding, translation to an NRZ-L signal (representing logic 1 and 0 by +A and −A voltages, respectively).

Additionally, said general QPSK modulator block diagram 2700 can incorporate differential coding so that data is decoded by phase changes rather than values of phase alone. Also, all QPSK telemetry schemes include randomization of the data so that bit values are equally likely.

Thus, the data entering the Splitter is equally likely A or −A, that being the only input characteristic of interest to the problem being addressed herein.

The data from said data source 2702 is split into two separate data streams, referred to as In-phase and Quadrature or commonly as I and Q, by selecting alternating values. These I and Q values are modulated at a symbol rate of ½ the incoming bit rate. Ignoring the optional blocks for the moment, these I and Q values are multiplied by cosine and sine samples, respectively, emanating from the Sine Wave Generator at the desired carrier frequency. The resulting signals are linearly added together to create the QPSK Output that, after corruption in frequency by Doppler, will be the signal input to the Doppler estimation receiver.

Telemetry signals are bandlimited and that introduces additional constraints for the modulator design and, thereby, additional considerations for Doppler estimation. Without the Optional blocks in said general QPSK modulator block diagram 2700, the QPSK signal will change by 0°, ±90°, or 180° at the symbol rate of ½ the data bit rate. These transitions in carrier phase, especially 180°, represent a shock to the system causing a widening of the signal bandwidth. The introduction of a half-symbol (1 bit period) delay in the Q data stream modifies the amount of phase change to 0° or ±90° although it happens at the bit rate rather than the symbol rate. This prepends the O (offset) to the QPSK name.

A second method for bandwidth reduction is the purposeful addition of intersymbol interference (ISI) to the signals. Normally, the interference to a signal symbol by symbols occurring before or after that symbol would be viewed as a bad thing for demodulation. However, this ISI is controlled to smooth the phase transition through these changes requiring a symbol synchronization capability at the receiver so that incoming signal phase is always sampled at the correct timing. The Optional Filters inject the ISI into the modulator by shaping these signals. Shaping prepends the S to the OQPSK name.

Offset and shaping create Continuous Phase Modulation schemes whose intent is to reduce the required channel bandwidth of the transmitted signal. Telemetry uses Continuous Phase Modulation for transmission of data. The shaping filter designs define each scheme but are of no interest to the problem addressed herein beyond the added difficulty of symbol synchronization.

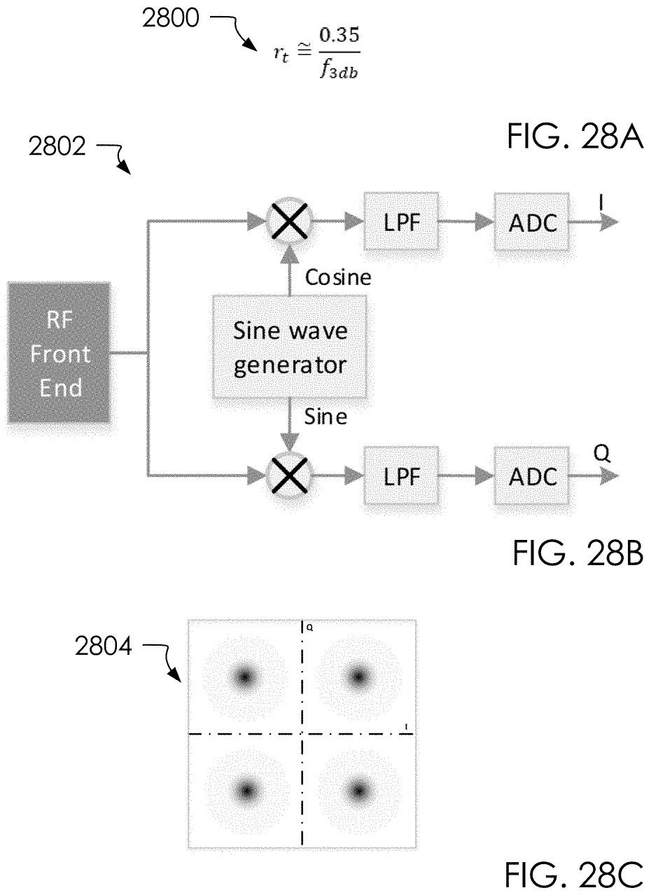

FIGS. 28A, 28B, and 28C illustrate an equation 2800, a basic quadrature receiver diagram 2802, and an ideal QPSK constellation 2804, respectively.

CPFSK Modulation Methods

Unlike a QPSK scheme, CPFSK uses frequency shifts of the carrier frequency to carry the information over the channel. The carrier signal's frequency is shifted up or down a fixed amount depending on the incoming bit stream. This shifting is at the bit rate so that the bit rate and symbol rate are the same.

IRIG 106-20 recommends lowpass filtering of the incoming NRZ-L signal by a filter with a bandwidth of 0.7 times the Bit Rate. Optimum peak frequency deviation recommended is 0.35 times the bit rate which is controlled by the value of the amplitude of the NRZ-L parameter, A.

A single-pole RLC low-pass filter with 3 dB bandwidth of f3db will have a pulse rise time, rt, from 10% amplitude to 90% amplitude as shown in said equation 2800.

The pulse time (bit time), tB, is the reciprocal of the bit rate.

Thus, the rise time is approximately one-half of the bit time. This makes clear that the carrier will be at, or near, the modulation frequency for about half of each bit time. This is an important result for use in the CPFSK Analysis section below.

Quadrature Receiver

QPSK Reception Methods

A quadrature receiver will downmodulate the received signal by both sine and cosine versions of a carrier frequency as shown in said basic quadrature receiver diagram 2802. If the originally transmitted carrier was used at the demodulator then the carrier would be perfectly canceled out and only Doppler and modulation would remain. Imperfections in crystal clocks would, however, leave a slight frequency difference between the transmitted frequency and the receiver's replication of that carrier frequency that will be discussed later.

The results of quadrature reception are complex samples with an I (in phase with local oscillator) component and a Q (quadrature phase with local oscillator) component. Said basic quadrature receiver diagram 2802 shows the receiver as analog but will more likely be implemented digitally with the ADC following the RF Front end.

The (I, Q) samples output by the receiver, if sampled at the modulation symbol rate, in synchronization with the symbols and with carrier and Doppler removed, when plotted (I vs Q), would take the form of said ideal QPSK constellation 2804. There are four distinct phases for QPSK modulation, each phase represents one of the four possible combinations of two bits. The possible four phases will lie in the four quadrants of an (I, Q) plot due to the modulation on a square grid as long as equal amplitude modulation is used for I & Q. The four ideal points are shown as fuzzy representing the effect of receive noise. The average distance to the four points from the origin is representative of the received signal strength and the radius of the fuzziness represents noise power. As a result, the plot shows signal-to-noise ratio and the probability that a point has enough noise to change quadrant reflects the probability of an error.

A typical receiver will estimate and remove the carrier, including clock offset and Doppler combination, estimate I and Q values and go on to decode the transmitted bits. This project differs in that it is desired to remove any carrier, clock offset, modulation, noise and any other impairments in order to estimate the Doppler frequency.

An unknown transmitted carrier cannot be estimated from the received signal plus Doppler without additional information since the unknown Doppler simply changes the frequency of the original signal. It would be required to have at least a close estimate of the original carrier frequency that could be used in the estimation of the received carrier frequency. This received carrier frequency would consist of the original carrier frequency modified by the Doppler shift frequency and further modified by receiver carrier frequency offset. The effect on the constellation of said ideal QPSK constellation 2804 would be to cause a rotation of the constellation over time at a rate of the Doppler frequency plus the carrier offset frequency.

CPFSK Reception Methods

A FSK signal will communicate bit values by representation using one frequency or another. Continuous phase uses a filter to smooth the phase transitions between these frequencies. Even so, the latter part of any symbol will have constant phase changes due to the constant frequency being represented. Further, this phase change will be maximum or minimum depending on the bit being represented.

The receiver block diagram will be identical to the QPSK diagram shown in said basic quadrature receiver diagram 2802. Phase can be measured from I and Q values and phase differences from successive samples.

These characteristics of CPFSK suggest using phase differences, finding that part of symbols where phase differences are reasonably constant and taking that as a frequency estimate. Following several symbols, two frequency estimates should emerge. Ideally, they would be ±R where R is some value. However, a bias will exist between the two estimates and that bias will be the sum of the Doppler shift and the carrier frequency difference between said transmitter 1402 and said signal receiver 112.

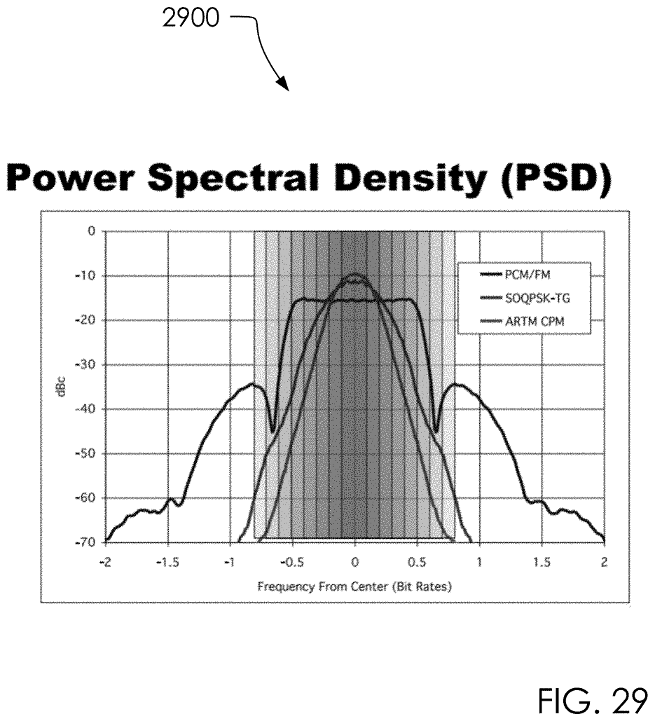

FIG. 29 illustrates a PSD chart 2900.

Said PSD chart 2900 comprises power spectral densities of data signals with various modulations (ARTM Advanced Range Telemetry Modulation).

The signal bandwidths expected for a variety of telemetry modulation schemes are shown in said PSD chart 2900. All schemes are constant-envelope, continuous phase modulations (CPM) that will have a symbol constellation as shown in said ideal QPSK constellation 2804. The (−35 dB) bandwidths of the shaped offset QPSK schemes have been reduced to less than the bit rate, a significant improvement over the older PCM/FM techniques.

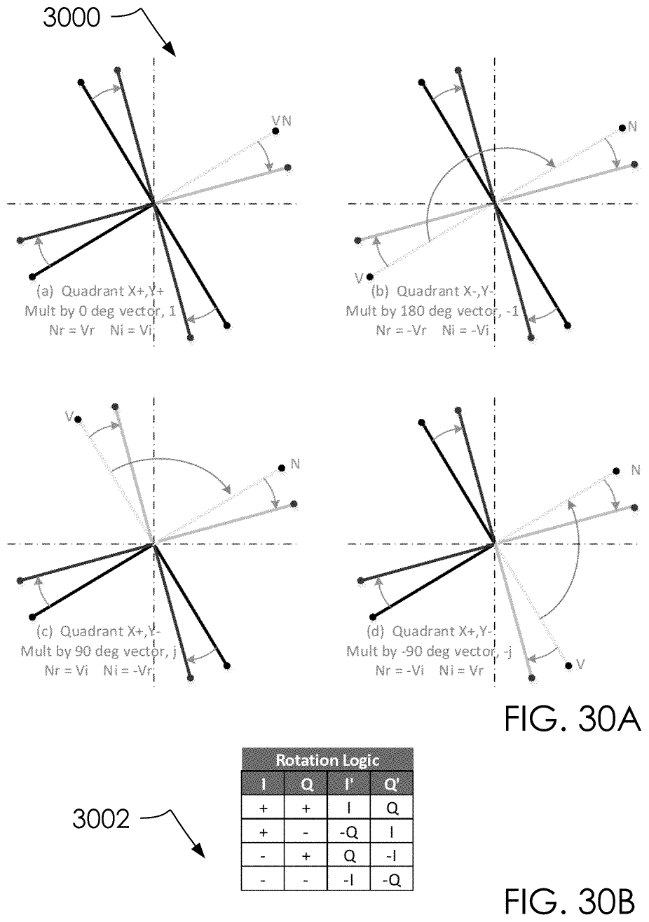

FIGS. 30A, and 30B illustrate a four-quadrant graphical representation 3000 of the removal of QPSK modulation, and a rotation logic table 3002, respectively.

QPSK Analysis

Removal of Modulation

A simple method for the removal of QPSK modulation is to map all signal (I, Q) samples into the same quadrant. When that is done, the constellation becomes a single point rotating with time at the rate of the Doppler frequency plus any carrier frequency difference. A method for doing this is shown graphically in said four-quadrant graphical representation 3000 for a point, V, rotated to a second point, N. An additional point is shown indicating that, if V were rotating with time then the direction of rotation would be unchanged. The process includes a quadrant check and then the negation and possibly the swap of I and Q values as shown in said four-quadrant graphical representation 3000 and further documented in said rotation logic table 3002.

This procedure will rotate each (I, Q) sample into the first quadrant of the (I, Q) plot. Ideally, the rotation of the constellation could be tracked from these clustered samples. There will be a jump, however, when the I, Q vector crosses a quadrant line. The rotated value will jump from the outgoing edge of the first quadrant to the incoming edge of the same quadrant. This must be considered when estimating rotation rate and, hence, Doppler frequency.

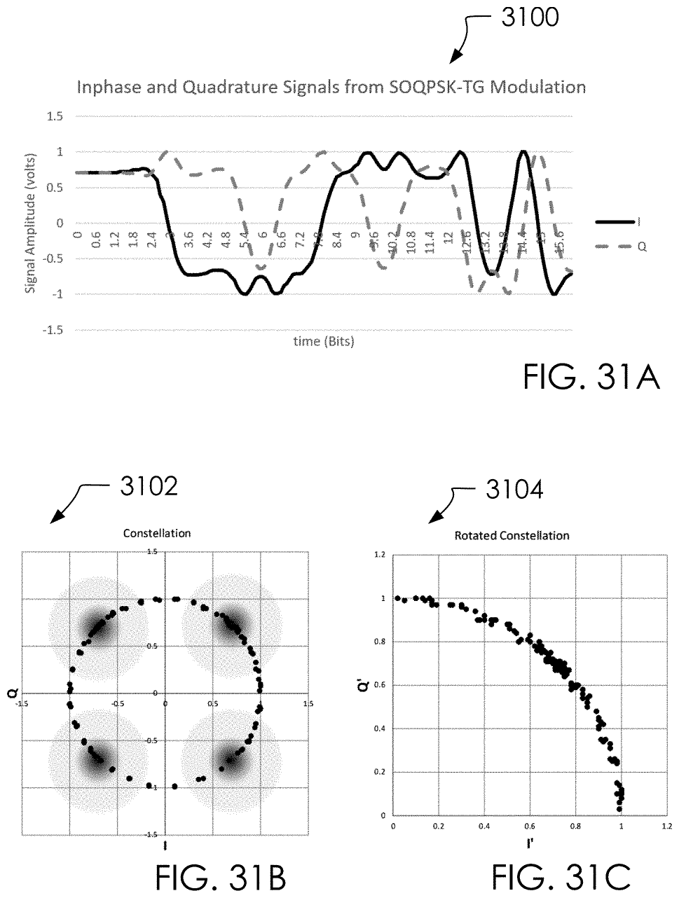

FIGS. 31A, 31B, and 31C illustrate an IQ signals chart 3100, a constellation chart 3102 and a rotated constellation chart 3104.

SOQPSK-TG Modulation Example

Shaped Offset Quadrature Phase Shift Keying-Telemetry Group (SOQPSK-TG) is one of the telemetry modulation schemes described in IRIG-106. An example of SOQPSK waveforms appears on page 47 of Advanced Modulation Techniques for Telemetry, A Short Course at the International Telemetering Conference, Las Vegas, NV, Oct. 23, 2017 by Terry Hill representing Quasonix. The waveforms in the example were hand digitized at a rate of 10 samples per bit time and are presented in said IQ signals chart 3100.

The samples were plotted as I vs Q as shown in said constellation chart 3102 and said rotated constellation chart 3104. Also represented in the figure are the expected locations of QPSK symbols as fuzzy points. It can be seen that the samples do somewhat cluster about these locations but are also spread about a circle due to the continuous phase characteristic of the modulation scheme. Additionally, the constant amplitude characteristic of the modulation can be observed, a characteristic of importance for power amplifiers.

Referring now to said rotated constellation chart 3104, the results of mapping to the first quadrant using the logic of said rotation logic table 3002. It is clearly seen that the points tend to cluster at 45 degrees and the modulation is gone. However, there are many other points coming from the oversampling that add to the confusion.

Both said constellation chart 3102 and said rotated constellation chart 3104 indicate a need for bit synchronization in order to select those samples of phase for use in carrier tracking.

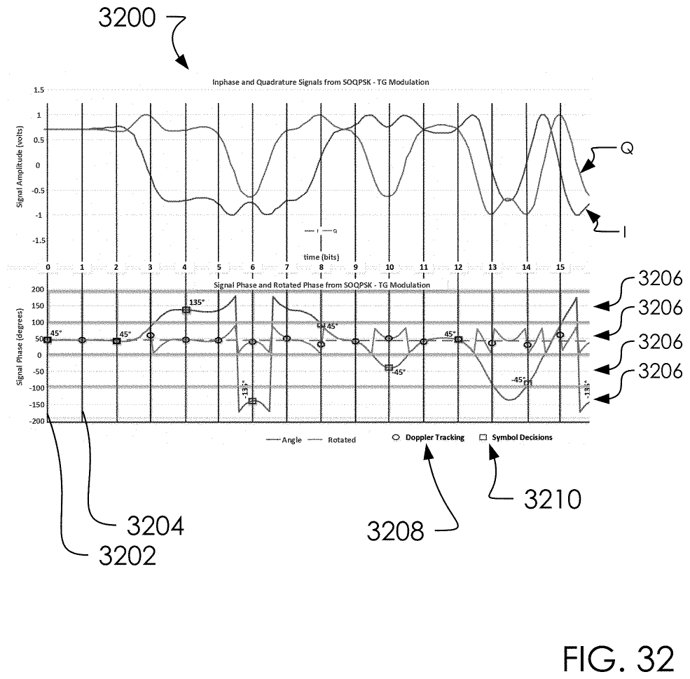

FIG. 32 illustrates a chart 3200 of doppler estimation from SOQPSK-TG waveforms.

Bit Synchronization and Doppler Estimation

A normal QPSK receiver will perform carrier recovery and then bit synchronization through means such as a Costas loop or raising the incoming signal to the second or fourth power and tracking the carrier. For data recovery, these methods work very well. They will track and remove the sum of the carrier frequency, clock inaccuracies and Doppler frequencies because these, including Doppler, are undesirable artifacts of reception. A Costas loop can provide estimates of Doppler plus Carrier Offset with careful design but provides delayed results due to tracking filters and these filters are modulation dependent.

A possible method for determining the Doppler frequency from received SOQPSK-TG waveforms is shown in said chart 3200 where the top plot repeats said IQ signals chart 3100 and the bottom plot shows the phase computed from the top plot and its mapping to the first quadrant of the (I, Q) plane. Superimposed on these plots are vertical lines indicating the appropriate bit sampling instants. Since SOQPSK-TG includes two bits per symbol, the first lines 3202 indicate the symbol sampling times whereas the second lines 3204 indicate the symbol half-way points dividing a symbol into two parts or bit times. Note said first lines 3202 and said second lines 3204 alternate, although each line is not labeled. Four horizontal bands 3206 are shown, each representing the range in phase of the four decision quadrants.

There are black circles 3208, labeled Doppler Tracking, placed in said chart 3200 at each bit time and red squares 3210, labeled Symbol Decisions, placed at each symbol time. The bit sampling lines were determined manually by creating a movable and stretchable set of lines that could be adjusted to what appeared to be the proper symbol sample times. The number of bits represented by this data set was known as would be the bit rate in practice. The raw data had been hand-digitized at 10 samples per bit time. Symbol times were chosen by sliding the vertical line set along the raw data plot until a maximum number of symbol times were located aligning the red lines. These times were recognized by phases near the center of horizontal bands while the rotated phases were near 45 degrees. The black lines were automatically aligned half way between the red lines.

The original I and Q data were created with zero carrier, clock drift, and Doppler. Thus, the Doppler estimate should be 0 Hz across the entire plot, a fact that was used in setting the bit timing. Allowing for graphical inaccuracies, the figure shows Doppler estimation points quite near a horizontal straight line at 45° and symbol decisions reasonably within decoding bands as would be expected.

These phase waveforms clearly demonstrate the importance of symbol tracking in demodulating the data (not of concern here) and of Doppler frequency tracking. A shift of timing in either direction would raise havoc with Doppler tracking and symbol decoding.

It was expected to see the Doppler Tracking points be at, or very near, the 45° value at symbol decode times since this is when the (I, Q) point is in quadrant centers so the mapped point should be in the upper left quadrant. What was not expected was to see the Doppler tracking points be at, or very near, the 45° value at all bit times. This seems due to the offset in the modulator that causes phase change at bit times rather than symbol times and limits the phase change to 0° or ±90°. If there is no phase change at a bit time then the mapped point stays at 45°. If there is a ±90° change at a bit time then the actual point moves from the center of a quadrant to the center of an adjacent quadrant which also will map to 45° in the first quadrant. Thus, all bit times provide an input to Doppler estimation.

Assuming the bit times are known, the Doppler frequency is the phase change from one bit time to the next. If the phase change is positive then said transmitter 1402 and said signal receiver 112 are approaching each other. If the phase change is negative then the two are separating from each other. Some amount of phase change averaging is likely going to improve the Doppler frequency estimates.

It is important to determine bit synchronization without removing Doppler. An important clue to doing such is that the desired angle of the Doppler tracking points is 45°. Sampling I and Q signals at a rate higher than a multiple of the bit rate provides numerous points to search. Since it is an angle of 45° that is sought then, importantly, this occurs when the magnitudes of I and Q are equal. This permits a simple magnitude equality test (with some allowance for noise and other implementation inaccuracies) to define candidate points. An additional criterion is that a series of these points must be spaced at the bit-rate time interval. Using these two requirements should produce a simple implementation of a Doppler tracking algorithm that will search and synchronize to the bit times and, once aligned, will determine the phase changes between these bit times using the first-quadrant, mapped (I, Q) data thereby estimating the Doppler frequency. The selected samples will also be used to estimate the RSSI.

Frequency deviation from that used by the receiver caused by Doppler or carrier offset will add an additional phase to each sample. Rather than the horizontal straight line of tracking points as shown in said chart 3200, the tracking points will continue to follow a straight line but with a slope dependent on the amount and sign of Doppler and carrier frequency offset.

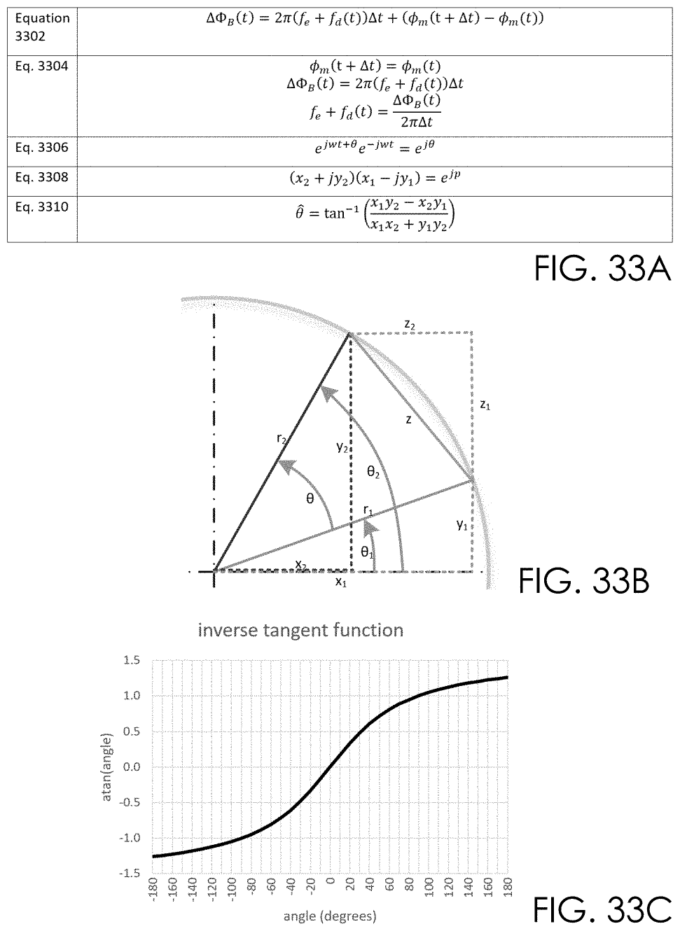

FIGS. 33A, 33B, and 33C illustrate a plurality of equations, an angle difference using coordinates diagram, and an inverse tangent function chart.

PCFSK Analysis

The receiver employed to measure Doppler in a PCFSK received signal is shown in said basic quadrature receiver diagram 2802 and is the same as used for QPSK schemes, as shown in an equation 3302.

The modulation in the CPFSK scheme will shift frequency from one symbol to the next or it will not. The modulation frequency will be settled for about one-half of a bit time. As such, in the last half of a symbol at a minimum an estimation can be calculated in the following three equations 3304. Which leads to an estimation of [ΔΦ]_B (t) can be done as follows.

Let θ represent the unknown phase in radians and ω represent the frequency of the received signal in radians per second. Then the received signal is e\hat{ }(jωt+θ) and the local oscillator is e\hat{ }(−jωt). The downmodulated signal can be expressed in an equation 3306.

This can be expressed using complex numbers using the components shown in FIG. 33B and in an equation 3308.

Angular direction is the sign of x_1 y_2−x_2 y_1 in the range {±180° } that can be used to test for the epoch.

Angle with sign can be estimated by an equation 3310.

This equation continues to work throughout rotation of the two vectors because the formulation is independent of rotation, θ_1. The chord, z, is always the hypotenuse of a right triangle with z1 and z2 as the orthogonal sides.

The range of the inverse tangent function is only required to be {−180, 180}. It is shown plotted in FIG. 33C.

Excel shows sign chatter at 180-degree separation.

Miss Distance Estimation

It has been shown mathematically and through example that RSSI and Doppler frequency shift contain information about the miss distance of an interceptor and its target. No other feature has yet to be proposed that contains this miss information within a telemetry or other type of signal emanating from the interceptor.

Data similar to the examples in FIG. 18B and FIG. 23C will be the inputs to a miss distance indicator algorithm that must determine an estimate of the actual miss distance, including estimates prior to the actual near miss.

Should the data presented be as complete as those two example figures then the estimation of the miss distance would simplify. There are equations for RSSI and Doppler frequency shift that contain the miss distance as a parameter. A best fit of these two equations to the corresponding data would provide two miss distance estimates and it would be a matter of determining which is most likely or making a weighted combination of the two.

However, it is desired to estimate the miss distance before it occurs in case the target and its receiver electronics or ground data link are destroyed prior to the actual miss. Thus, an algorithm is desired that will use all available information to determine an estimate of the miss distance and be structured to operate recursively, updating every time new data becomes available.

Observations about the Data

The graphs of FIG. 18B and FIG. 23C display the expected time history of data from an encounter. It is readily appreciated that these graphs display little variation whenever the interceptor is sufficiently far from the epoch that the miss distance becomes irrelevant. This prompts the definition of three ranges on these curves separated by the distance from the epoch, De, that makes the miss distance irrelevant in the calculation of range. De will normally be at least 10 times the maximum miss distance that the system is designed to operate. The Approaching Range (AR) is defined as approaching distances exceeding De. Similarly, the Departing Range (DR) is defined as departing distances exceeding De. The Near Range (NR) includes all distances between AR and DR.

The data collection process in all three ranges is identical. RF bursts, estimation of phase change, estimation of power level. One goal is to define the RSSI and Doppler curves in sufficient detail that accurate estimates of miss distance can be determined. The usefulness of the three ranges is to define the data that must be communicated to the ground. In the case of AR, the data communicated can be limited to only a few averages at the time of transition to NR. During NR the amount of data will be samples of RSSI and Doppler at the Doppler sampling rate. Transition into DR can drop the transmission to only a couple of averages over the number of samples used in the AR for averages.

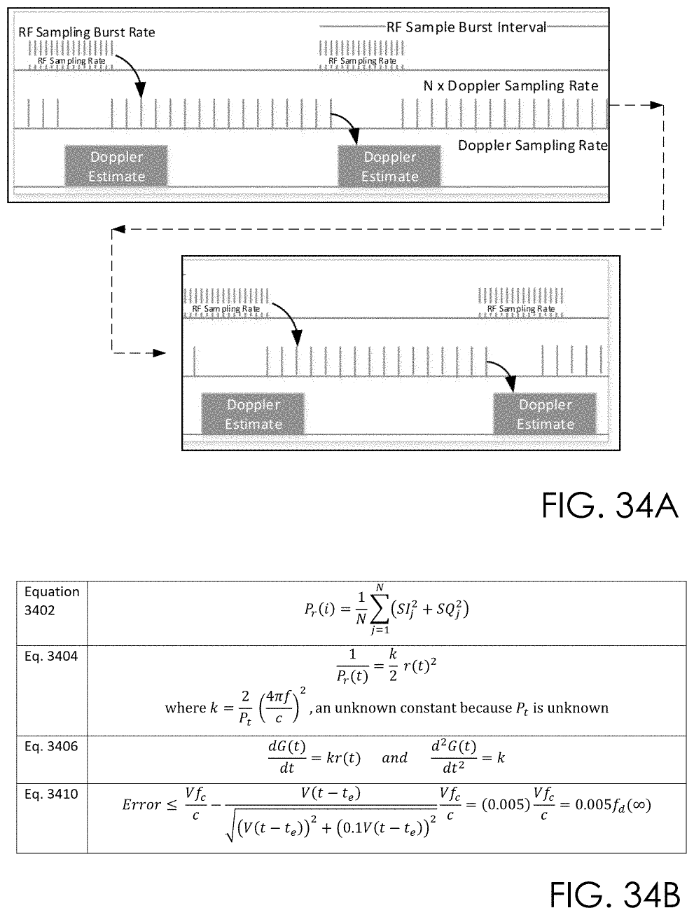

FIGS. 34A, and 34B illustrate a data sampling scheme and a plurality of equations.

Data Sampling Scheme

There are two sampling rates of interest to this problem and it is important to distinguish them. The first is the rate at which the incoming signal needs to be sampled. The second is the rate at which the Doppler frequency and RSSI need to be sampled and reported. The first sampling rate is lower bounded by the Nyquist rate and will be chosen so that useful measurements of phase change can be made, likely 8 times the Nyquist rate (45° between samples) or more, for detailed measurement of signal phase. The second sampling rate will be governed by the range of mission parameters and the number of samples needed to separate curves like those shown in FIG. 18B and FIG. 23C to yield the desired miss measurement accuracy.

The signal input is sampled at the desired RF sampling rate after down conversion to baseband. N complex samples are taken in a burst mode and written into I and Q FIFOs at the RF sampling rate. The N complex samples are extracted from the FIFO and processed to produce N estimates of RSSI and phase changes, Δp(t). The final step is to produce Doppler estimates at the Doppler sampling rate.

Processing in the Approaching Range

The data collection methodology and sampling using burst processing at the RF signal rate with RSSI and phase change estimation at the Doppler sampling rate provide the data inputs. It is assumed that the bit synchronization methods described above have been used to acquire and maintain bit synchronization and that the most reliable sample is taken at each bit.

RSSI

Processing of the RF burst samples will result in an average input power estimate in an equation 3402. Where SIj and SQj are the in phase and quadrature samples of the jth sample of the N-size burst.

A little manipulation of the free space path loss equation gives an equation 3404.

Defining G(t)=1/(P_r(t)) results in an equation 3406.

Thus, the second derivative of the reciprocal of receive power measurements is a constant and the first derivative is that constant times the range between said transmitter 1402 and said signal receiver 112. All assumes there are constant antenna beam pattern effects that will be true at large values of the range, r, where the value of d will also be insignificant in determining r.

When the second derivative begins to deviate from a constant value more significantly than can be explained by noise and in an increasing direction then the approach of the NR is heralded.

Doppler

The phase estimates coming from Doppler processing as described above are expected to be constant in the AR. These will be averaged and monitored for a deviation in the decreasing direction that cannot be explained by noise alone.

In the AR, d≤0.1Vt. The approximation error between the maximum Doppler asymptote and the estimate with d=0.1Vt is 0.5% or less. See an equation 3408.

Exiting the AR

RSSI and Doppler produce quantities that are expected to be constant from burst-to-burst given samples taken in bit synchronization. Unexplained deviation of either of these quantities can signal the end of the AR and the beginning of the NR. Evaluation of the exact logic will require a noise analysis of the estimates of both of these quantities to determine relative reliability and useful thresholds for decision.

Upon exiting, the data from the AR will include: an estimate of the maximum (Doppler+carrier frequency) shift; and an estimate of the constant, k, from which the power of the transmitter could be estimated if desired

Processing in the Departing Range

This processing can only be accomplished if data continues to be available. That requires the target electronics to survive the interceptor's passing. In this range the data is expected to behave and be processed similarly to the AR.

RSSI

The values of RSSI will be continually calculated as in the AR. These data can be used to aid in defining the moment that the interceptor passed through the epoch and to enhance the estimate of the miss distance.

Doppler

Collection and averaging of Doppler samples will be performed. These samples will be used on the ground to estimate the carrier frequency offset by averaging the DR value with the AR value. Subtracting the carrier frequency offset from the Doppler data will remove this error source and improve the estimate of miss distance.

Exiting the DR

The data available for post processing will include: an estimate of the maximum negative (Doppler+carrier frequency) shift; an estimate of the constant, k, from which the power of the transmitter could be estimated if desired; and an estimate of the departing speed of the interceptor using multiple samples of r(t) to estimate the change of range with time.

Processing in the Near Range

Collection of RSSI and Doppler samples will be performed as in other ranges. Values of RSSI and Doppler will be used to determine when the NR range has been exceeded and the continuous transmission of sampled data to the ground can be discontinued.

Post Processing

Processing the NR data will take advantage of the dramatic RSSI curve's rise and fall and the monotonically decreasing Doppler curve. Formulas exist dependent on miss distance that can be employed to generate a series of curves as has been done in FIG. 18B for RSSI and FIG. 32C for Doppler. These curves can be made more realistic by using the data from the AR and the DR. It is possible to visualize selection of the two curves that best fit the data for RSSI and for Doppler and see if the miss distances used to create these curves agree.

The actual method for determining a miss distance estimate involves the use of determining what curve parameters, including miss distance, will generate a function that best fits the available data. This statement requires defining what is meant by the term “best fits”. This is defined in this instance to be in the Minimum Mean-Squared Error (MMSE) sense. Using this method, a function is defined and the number of unknowns is determined. The functional form is used to define a relationship that is to exist between all samples in the data set in a time-ordered fashion. An expression is written defining the difference between each data sample and the function evaluated at the sample time. This defines the matching error at each sample which can be positive or negative. These errors are squared so that errors will not cancel other errors and also to emphasize larger errors. The results are accumulated into an expression for the mean-squared error of the match. Differentiation with respect to each unknown is done and the results set to zero to define minimums. This produces a number of equations equal to the number of unknowns. The equations are then solved simultaneously for all of the unknowns, one of which is the miss distance.

Since there are two sets of data, RSSI and Doppler, there will be two estimates of miss distance. They may, or may not, be exactly equal. A method is required to determine which estimate is better or to combine the two in an overall best estimate of miss distance. Mathematically there is a means of deciding the best match to a curve by evaluating the value of the MMSE after the parameters have been determined. Guidance can be found in looking at the curves in FIG. 18B and FIG. 32C. The curves in FIG. 18B are more distinctly spaced for small values of miss distance and tend to blend together for the larger miss distances. This suggests that RSSI would be more accurate at shorter miss distances than larger ones. The curves of FIG. 32C tell the opposite story. As the miss distance increases, the curve separation increases suggesting that estimates of miss distance based upon Doppler will likely be more accurate as the miss distance increases.

The quality of curve fit to data is represented by the MMSE. This provides a means for choosing one estimate over another or for weighting the two estimates in a combination.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

These parts are found in the specification and drawings:
said stationary diagram 100,
Said approaching vehicle diagram 102,
Said passing vehicle diagram 200,
Said departing vehicle diagram 202,
Said two moving vehicles 104,
Said first vehicle 104b,
Said second vehicle 104a,
Said space 108,
Said broadcast signal 110,
Said signal receiver 112,
Said control system 114,
Said miss distance 116,
Said first distance 118,
Said minimum distance 204,
Said second distance 206,
Said received signal 120,
Said time-minimum-distance 210,
Said Doppler frequency shift chart 310,
Said method of calculating a distance between transmitters and receivers with Doppler signals 300,
Said observation period 302,
Said starting time 304,
Said ending time 306,
Said slope characteristic 308,
Said frequency shift 312,
Said fifth equation 500e,
Said velocity vector illustration 400,
Said first equation 500a,
Said second equation 500b,
Said third equation 500c,
Said fourth equation 500d,
Said sixth equation 500f,
Said closing velocity 504,
Said transmitted frequency 502,
Said breakdown of the steps for the fourth equation 600,
Said flyby model illustration 700,
Said method of calculating a miss distance using a flyby model 704,
Said propagation velocity 702,
Said initial velocity 806,
Said initial distance 804,
Said seventh equation 800a,
Said eighth equation 800b,
Said ninth equation 800c,
Said tenth equation 800d,
Said closing distance 802,
Said Doppler frequency shift chart 900,
Said plurality of curves 904,
Said integral model 902,
Said eleventh equation 1000a,
Said twelfth equation 1000b,
Said thirteenth equation 1000c,
Said fourteenth equation 1000d,
Said fifteenth equation 1000e,
Said sixteenth equation 1100a,
Said seventeenth equation 1100b,
Said eighteenth equation 1100c,
Said nineteenth equation 1100d,
Said twentieth equation 1100e,
Said twenty-first equation 1100f,
Said integral method of calculating a miss distance 1002,
Said scalar miss distance 1004,
Said initial closing velocity 1102,
Said twenty-second equation 1200a,
Said twenty-third equation 1200b,
Said twenty-fourth equation 1200c,
Said twenty-fifth equation 1200d,
Said twenty-sixth equation 1200e,
Said twenty-seventh equation 1200f,
Said frequency range 1202,
Said ideal method 1300,
Said practical method 1302,
Said actual interceptor frequency 1304,
Said interceptor frequency 1306,
Said transmitter path 1400,
Said transmitter 1402,
Said comparison table 1500,
Said speed V 1904,
Said equation 1900,
Said time varying approach angle 1906,
Said table 2002,
Said probability density functions 2000,
Said equation 2102,
Said equation 2104,
Said equation 2106,
Said equation 2108,
Said equation 2110,
Said equation 2112,
Said equation 2114,
Said equation 2116,
Said three equations 2118,
Said equation 2122,
Said two equations 2124,
Said equation 2126,
Said equation 2128,
Said equation 2130,
Said equation 2202,
Said equation 2204,
Said two equations 2206,
Said two relationships 2208,
Said miss scenario 2310,
Said equation 2302,
Said equation 2304,
Said two equations 2306,
Said equation 2308,
Said equation 2402,
Said equation 2404,
Said equation 2406,
Said Slope of Doppler Estimates chart 2500,
Said slope 2502,
Said exaggerated example of I/Q imbalance chart 2600,
Said general QPSK modulator block diagram 2700,
Said data source 2702,
Said equation 2800,
Said basic quadrature receiver diagram 2802,
Said ideal QPSK constellation 2804,
Said PSD chart 2900,
Said four-quadrant graphical representation 3000,
Said rotation logic table 3002,
Said IQ signals chart 3100,
Said constellation chart 3102,
Said rotated constellation chart 3104,
Said chart 3200,
Said first lines 3202,
Said second lines 3204,
Said Four horizontal bands 3206,
Said black circles 3208,
Said red squares 3210,
Said equation 3302,
Said three equations 3304,
Said equation 3306,
Said equation 3308,
Said equation 3310,
Said equation 3402,
Said equation 3404,
Said equation 3406,
Said equation 3408, and
two formulas 2120.

1. A method of calculating a distance between transmitters and receivers with Doppler signals for determining a miss distance of two moving vehicles using the physical phenomenon of the Doppler effect, comprising:
emitting a broadcast signal with a transmitter from one among said two moving vehicles and sensing and recording a portion of said broadcast signal with a signal receiver on another among said two moving vehicles,
analyzing a received signal over an observation period,
calculating a slope characteristic of said received signal over said observation period,
and calculating said miss distance between said two moving vehicles based on said slope characteristic;
wherein, said observation period comprises a starting time, a time-minimum-distance and an ending time.

2. The method of calculating a distance between transmitters and receivers with Doppler signals of claim 1, wherein:
said method of calculating a distance between transmitters and receivers with Doppler signals comprises
calculating a closing velocity using both a transmitted frequency and said received signal.

3. A method of calculating a distance between transmitters and receivers with Doppler signals for determining a miss distance between a transmitter moving along a transmitter path relative to a signal receiver using the physical phenomenon of the Doppler effect, comprising:
broadcasting a broadcast signal with said transmitter from one among two moving vehicles and capturing and recording a portion of said broadcast signal with said signal receiver on another among said two moving vehicles,
measuring a Received Signal Strength Indicator (“RSSI”) based on a received signal,
measuring a change in a Doppler frequency shift in said received signal,
removing any carrier offset and modulated data of said received signal to accurately recover the Doppler components,
calculating a minimum distance and a time-minimum-distance between said transmitter and said signal receiver; wherein
Said time-minimum-distance, also referred to as an epoch, comprises a time at which said miss distance is at said minimum distance as between said signal receiver and said transmitter, and
the period with said transmitter and said signal receiver passing one another is referred to as an encounter.

4. The method of calculating a distance between transmitters and receivers with Doppler signals of claim 3, wherein:
said transmitter is attached to a second vehicle moving along said transmitter path.

5. The method of calculating a distance between transmitters and receivers with Doppler signals of claim 3, wherein:
calculating said time-minimum-distance comprises calculating a slope of the Doppler shift slope, and
determining where said slope of the Doppler shift slope changes from positive to negative.

6. The method of calculating a distance between transmitters and receivers with Doppler signals of claim 3, wherein:
calculating said time-minimum-distance comprises calculating a slope of the Doppler shift slope and determining where said slope of the Doppler shift slope is maximum.

7. The method of calculating a distance between transmitters and receivers with Doppler signals of claim 3, further comprising:
compensating for differences in a transmitter clock in said transmitter and a receiver clock in said signal receiver to minimize errors in frequencies of said received signal at said signal receiver.

8. The method of calculating a distance between transmitters and receivers with Doppler signals of claim 3, wherein:
the Doppler frequency shift of the transmitter's carrier frequency depends on a speed V and a time varying approach angle of said transmitter relative to said signal receiver, with said transmitter moving through a space at said speed V on said transmitter path, said signal receiver at said time varying approach angle from said transmitter path at time t.

9. The method of calculating a distance between transmitters and receivers with Doppler signals of claim 3, wherein:
calculating said minimum distance using RSSI to achieve higher fidelity than with doppler alone.

10. The method of calculating a distance between transmitters and receivers with Doppler signals of claim 3, wherein:
said transmitter outputs a carrier signal of constant power including the modulation impressed upon said broadcast signal;
wherein, said changes in the general characteristics of said received signal comprises:
a signal strength due to the changing distance between said transmitter and said signal receiver, the path loss;
a signal strength due to the beam pattern shapes of transmit and receive antennas; and
a doppler frequency shift as said transmitter moves from approaching to departing.

11. The method of calculating a distance between transmitters and receivers with Doppler signals of claim 3, wherein:
RSSI will be increasing and Doppler will be positive when approaching;
RSSI will be decreasing and Doppler will be negative when departing;
RSSI will be maximum and Doppler will be zero at said time-minimum-distance.

12. The method of calculating a distance between transmitters and receivers with Doppler signals of claim 3, further comprising:
calculating a slope characteristic of said received signal over an observation period, and
and calculating said miss distance between said two moving vehicles based on said slope characteristic;
wherein, said slope characteristic are expressed as a frequency shift;
said frequency shift is calculated by subtracting a transmitted frequency from said received signal;
said time-minimum-distance is calculated when said frequency shift equals zero.

13. A method of calculating a distance between transmitters and receivers with Doppler signals for determining a miss distance between a transmitter moving along a transmitter path relative to a signal receiver using the physical phenomenon of the Doppler effect, comprising:
broadcasting a broadcast signal with said transmitter from one among two moving vehicles and capturing and recording a portion of said broadcast signal with said signal receiver on another among said two moving vehicles,
measuring a Received Signal Strength Indicator (“RSSI”) based on a received signal,
measuring a change in a Doppler frequency shift in said received signal,
removing any carrier offset and modulated data of said received signal to accurately recover the Doppler components,
calculating a minimum distance and a time-minimum-distance between said transmitter and said signal receiver; wherein
Said time-minimum-distance, also referred to as an epoch, comprises a time at which said miss distance is at said minimum distance as between said signal receiver and said transmitter, and
the period with said transmitter and said signal receiver passing one another is referred to as an encounter;
said transmitter outputs a carrier signal of constant power including the modulation impressed upon said broadcast signal;
wherein, said changes in the general characteristics of said received signal comprises:
a signal strength due to the changing distance between said transmitter and said signal receiver, the path loss;
a signal strength due to the beam pattern shapes of transmit and receive antennas; and
a doppler frequency shift as said transmitter moves from approaching to departing.

14. The method of calculating a distance between transmitters and receivers with Doppler signals of claim 13, wherein:
RSSI will be increasing and Doppler will be positive when approaching;
RSSI will be decreasing and Doppler will be negative when departing;
RSSI will be maximum and Doppler will be zero at said time-minimum-distance.
